(19) United States
(12) Patent Application Publication
(10) Pub. No.: US 2026/0165343 A1
(43) Pub. Date: Jun. 18, 2026

(54) AN EDIBLE FOOD PRODUCT AND A MANUFACTURING METHOD THEREOF

(71) Applicant: SUPRÊME, Evry-Courcouronnes Cedex (FR)

(72) Inventors: Victor SAYOUS, Evry-Courcouronnes Cedex (FR); Victor CONVERSA MARTINEZ, Evry-Courcouronnes Cedex (FR); Phuong Anh DANG, Evry-Courcouronnes Cedex (FR)

(21) Appl. No.: 19/127,268

(22) PCT Filed: Nov. 9, 2023
(86) PCT No.: PCT/EP2023/081373

§ 371 Date: May 5, 2025

(30) Foreign Application Priority Data
Nov. 9, 2022 (EP) 22315269.5
Nov. 9, 2022 (EP) 22315270.3
Nov. 9, 2022 (EP) 22315271.1
Apr. 25, 2023 (EP) 23315109.1

(51) Int. Cl. A23J 3/04; A23J 3/22

(52) U.S. Cl. CPC A23J 3/04; A23J 3/227

(57) ABSTRACT

The invention relates to a method (100) of manufacturing an edible food product, said method (100) using a protein matrix, and a fatty matrix, said method (100) comprising the following steps: Processing (140) the protein matrix to form one or more edible protein thread(s) (220) using a threading device (10); Guiding (150) the one or more edible protein thread(s) (220) on a collecting device (30) using a guiding device (50); And adding (160) the fatty matrix on the one or more edible protein thread(s) (220) using a dispensing device (60), so that the fatty matrix is positioned within the assembly of edible protein thread(s) (280). The invention also relates to a system (1) for manufacturing an edible food product and an edible food product obtainable by a method (100) according to the invention.

### FIELD OF THE INVENTION

The present invention relates to the field of food manufacture. In particular, the invention relates to the field of meat substitutes. In particular, this invention relates to cultured cell-based meat. This invention can provide new edible food products comprising protein threads and a fatty matrix. These edible food products with a marbled meat appearance can be considered as substitutes for conventional meat.

### DESCRIPTION OF RELATED ART

From 2020 to 2050, the world population will rise by an estimated 2 billion (United Nations, 2015). Humanity will face major challenges among which is food production, including meat production. Traditional meat production is a resource-intensive process that generates a significant environmental footprint. Domesticated animals are raised in agricultural settings requiring substantial quantities of fresh water, feed, land, and other resources (Mark J Post: “Cultured meat from stem cells: Challenges and prospects” Meat science, Elsevier Science, GB, vol 92, no 3, 3 Apr. 2012, pages 297-301). Consequently, food production is already considered responsible for approximately 26% of global greenhouse gas (GHG) emissions, of which livestock & fisheries account for 31%. A reduction in global conventional meat consumption could lead to a significant reduction in emissions of greenhouse gases related to climate change (Martin & Brandão, 2017. Evaluating the environmental consequences of Swedish food consumption and dietary choices. Sustainability, 9 (12), 2227). This is amplified if reductions are made in countries where meat consumption is high or rising (Stoll-Kleemann & Schmidt, 2017, Reducing meat consumption in developed and transition countries to counter climate change and biodiversity loss: A review of influence factors. Regional Environmental Change, 17 (5), 1261-1277.; Collier et al. 2021, Identifying barriers to decreasing meat consumption and increasing acceptance of meat substitutes among Swedish consumers; Appetite 167 (2021) 105643.).

Moreover, animal welfare has been a growing concern. For example, the European Union has put in place various laws concerning animal welfare since 1986. Various directives provide rules for the protection of laying hens (in 1986 and 1988), calves and pigs (in 1991), and, in 1998, the Council directive 98/58/EC on the protection of animals kept for farming purposes has established general rules concerning the protection of animals, whatever the species.

Several meat substitutes have been developed from insects, vegetable components and/or cultured animal, fungus or vegetable cells (i.e. cell technology). In particular, cell technologies are being rapidly developed to respond to new demands of consumers.

Crucial to the increase people's willingness to consume meat replacements, the product, as a substitute, should mimic the aesthetic and organoleptic qualities of meat such as size, appearance, flavor, mouthfeel and texture (Macdiarmid et al., 2016, Eating like there's no tomorrow: Public awareness of the environmental impact of food and reluctance to eat less meat as part of a sustainable diet. Appetite. 2016 Jan. 1; 96:487-493).

It has been proposed to produce an extruded food product comprising cultured animal cells (WO2022047263). However, the resulting extruded food bears little resemblance to what a consumer would expect from a meat product, especially if the desired appearance is a raw product and flavor kept within the meat piece.

Also, recent advances in muscle tissue engineering, such as scaffolding (Linzi Li et al. 2022. Chitosan-sodium alginate-collagen/gelatin three-dimensional edible scaffolds for building a structured model for cell cultured meat. International Journal of Biological Macromolecules. Volume 209, Part A, 1 Jun. 2022, Pages 668-679) and bioprinting combined with physicochemical stimulation, have allowed the design and manufacture of pieces of meat that increasingly emulate the natural structure and composition (Xin Guan et al. Bioprocessing technology of muscle stem cells: implications for cultured meat. Trends in Biotechnology. Volume 40, Issue 6, June 2022, Pages 721-734). However, there are regulatory issues and obvious technical obstacles to the transition to large-scale manufacturing for such technology.

Moreover, the complexity is further increased when it is desired to produce meat substitutes having particular fat-lean patterns. This applies in particular to fat-lean patterns which can be found in nicely textured fatty meats such as marbled meats and in particular salmon or tuna.

Hence, there are important needs to find a satisfactory alternative to animal slaughtering and intensive meat production means in order to produce an edible food product that has a pleasant flavor, a texture and an appearance corresponding to that expected from conventional meat. In particular, there is a need for an edible food product comprising protein threads which can mimic the conventional meat texture, appearance and mouthfeel, in particular marbled meat.

### SUMMARY OF THE INVENTION

The following sets forth a simplified summary of selected aspects, embodiments and examples of the present invention for the purpose of providing a basic understanding of the invention. However, this summary does not constitute an extensive overview of all the aspects, embodiments and examples of the invention. Its sole purpose is to present selected aspects, embodiments and examples of the invention in a concise form as an introduction to the more detailed description of the aspects, embodiments and examples of the invention that follow the summary.

The invention aims to overcome the disadvantages of the prior art. In particular, the invention proposes a method of manufacturing an edible food product, said method using a protein matrix, and a fatty matrix, said method comprising the following steps:
Processing the protein matrix to form one or more edible protein thread(s) using a threading device;
Guiding the one or more edible protein thread(s) on a collecting device using a guiding device; the guiding device and the collecting device cooperating so as to form an assembly of edible protein thread(s); and
Adding the fatty matrix on the one or more edible protein thread(s), using a dispensing device, preferably the fatty matrix is added on the edible protein thread(s) while they are being collected by the collecting device, so that the fatty matrix is positioned within the assembly of edible protein thread(s).

Such an edible food product has a texture similar to the texture of conventional meat notably thanks to the particular combination of protein threads and fatty matrix. As the protein threads are combined with a fatty matrix, this method can allow the creation of specific patterns of protein threads and fatty matrix while increasing the yield and minimizing materials losses during the production of meat alternatives. The combination of protein threads and fatty matrix according to the invention can exhibit a great diversity of shape and size, unlike high moisture extrusion usually used for structuring plant-based products. Also, the method according to the invention can produce three-dimensional products with particular fat-lean pattern and thicker final products compared to conventional extrusion.

The edible food product can take advantage of the presence of protein threads having a texture similar to the texture of meat fibers and in particular an expected juiciness. Furthermore, this edible food product can have an appearance corresponding to that expected from a marbled piece of conventional meat.

In particular, the method according to the invention allows the production of an edible food product with a raw aspect. With such an advantage, a consumer can still cook the product in the same manner as conventional meat and experience the same organoleptic qualities. This method is scalable and allows the production of aligned threads with a broad range of fat and proteins, with controlled fat content and marbling pattern, with no oxidation of the fat while processing, and with low risk of denaturation of the proteins.

The edible food product according to the invention can be thus considered as an alternative to a conventional meat product. The edible protein threads combined with the fatty matrix can be processed to mimic a large variety of meat fibers, including but not limited to beef meat, scallop, crab meat pulp, chicken breast, duck breast, tuna meat, salmon meat, and has a matching meaty or fishy flavor.

According to other optional features of the method of manufacturing an edible food product according to the invention, it can optionally include one or more of the following characteristics alone or in combination:
the fat of the fatty matrix comprises at least 4% in weight of stearic acid compared to the total weight of the fat of the fatty matrix. Such concentration can improve the edible food product in particular to produce a juiciness and appearance before and after cooking, corresponding to that expected from a marbled piece of conventional meat.
the fat of the fatty matrix comprises at most 35% in weight of palmitic acid compared to the total weight of the fat of the fatty matrix. Such concentration can improve the edible food product in particular to produce a juiciness and appearance before and after cooking, corresponding to that expected from a marbled piece of conventional meat.
the fat of the fatty matrix comprises at least 3.5% in weight of polyunsaturated C18 fatty acids compared to the total weight of the fat of the fatty matrix. Such concentration can improve the edible food product in particular to produce a juiciness and appearance before and after cooking, corresponding to that expected from a marbled piece of conventional meat.
the protein matrix comprises at least 5% in weight of proteins compared to the total wet weight of the protein matrix and the protein matrix comprises at least 1% in dry weight of cultivated non-human animal cells compared to the total wet weight of the protein matrix. Preferably, the protein matrix comprises at least 10% in weight of proteins compared to the total wet weight of the protein matrix and the protein matrix comprises at least 1% in dry weight of cultivated non-human animal cells compared to the total wet weight of the protein matrix.
the protein matrix comprises at least 0.25% in weight of myofibrillar proteins compared to the total weight of proteins.
the collecting device is moving while cooperating with the guiding device, preferably the movement of the collecting device comprises a rotation. This participates in a scalable method allowing marbling patterns.
the edible protein threads are collected by winding them around the collecting device, creating an assembly of protein threads; the fatty matrix being associated with the edible protein threads as they wind around the collecting device. This participates in a scalable method allowing marbling patterns.
the guiding device and the collecting device are automatically operated to ensure that the edible protein thread(s) are deposited on the collecting device according to a deposition pattern, said deposition pattern being defined so as to generate an expected marbling pattern in the edible food product.
the formation of the edible protein thread(s) includes a step of wet spinning, a step of dry spinning, a step of electro-spinning or a step of dry jet wet spinning. In particular it can include a step of wet spinning or a step of dry jet wet spinning. This participates in a scalable method with a precise control of the threads composition without protein denaturation.
the protein matrix comprises animal proteins, said animal proteins being from non-human cultivated animal cells; preferably the protein matrix comprises disrupted non-human cultivated animal cells and/or intact non-human cultivated animal cells. This contributes to one of the main objectives of the invention.
the fat of the fatty matrix comprises at least 20% in weight of unsaturated fatty acids compared to the total weight of the fat of the fatty matrix. This contributes to the organoleptic properties of the produced threads.
it further comprises a step of adding an elastomeric protein matrix to the assembly, during its formation, so that the elastomeric protein matrix is positioned within the assembly of edible protein thread(s). This contributes to the organoleptic properties of the threads produced.
the elastomeric protein matrix comprises elastomeric protein selected from: extracellular matrix non-human animal proteins; plant proteins; microorganism proteins; algae proteins; and combination thereof.
the elastomeric protein matrix is added on the one or more edible protein threads:
   in the form of preformed network, for example in the form of a film like structure;
   in the form of a preformed protein-polysaccharide composite network, for example in the form of a film like structure;
   through a coaxial spinning process, the elastomeric protein matrix being used on the outer needle;
   in the form of a solution, from the moment the edible protein thread is guided by the guiding device to the collecting device; or
   in the form of a solution, from the moment the edible protein thread is in contact with the collecting device.
the step of processing the protein matrix to form one or more edible protein thread(s) comprises contacting the protein matrix with a coagulation bath to form an edible protein thread, preferably said protein matrix being at a temperature lower than 65° C.; the protein matrix comprising polyvalent ion or a polyelectrolyte and the coagulation bath comprising a polyvalent ion when the protein matrix comprises a polyelectrolyte or polyelectrolyte when the protein matrix comprises a polyvalent ion.
it further comprises a step of monitoring, by a monitoring device, the assembly during its formation to generate assembly data, preferably the monitoring comprises an acquisition of a video stream comprising the assembly during its formation. This participates in a scalable method allowing marbling patterns.
it further comprises a step of controlling the guiding device, the fatty matrix dispensing device and/or the collecting device based on the assembly data, preferably it comprises a modification of initial instructions based on the assembly data. This participates in a scalable method allowing marbling patterns.

The invention also relates to an edible food product obtainable from a method according to the invention. In particular, the edible food product obtainable according to the invention comprises an assembly of edible protein thread(s) within which is positioned a fatty matrix. Preferably, the edible protein threads are heat-resistant threads. In particular, the proteins of the edible protein threads can be selected among plant proteins, microbial proteins, algae proteins, animal proteins, fungal proteins, and a combination thereof. Preferably, the proteins of the edible protein threads comprise at least animal proteins from non-human cultivated animal cells.

The invention also relates to a system for manufacturing an edible food product, said system comprising a first container adapted to include a protein matrix and a second container adapted to include a fatty matrix, said system comprising:
A threading device configured to process the protein matrix contained in the first container to form one or more edible protein thread(s);
A guiding device configured to guide the one or more edible protein thread(s) on a collecting device; the guiding device and the collecting device being configured to cooperate so as to form an assembly of edible protein thread(s); and
A dispensing device configured to add the fatty matrix on the one or more edible protein thread(s) so that the fatty matrix is positioned within the assembly of edible protein thread(s).

According to other optional features of the system for manufacturing an edible food product according to the invention, it can optionally include one or more of the following characteristics alone or in combination:
the guiding device comprises one or more housing for the edible protein thread(s);
the guiding device is configured to move horizontally across the width of the collecting device to guide the fiber across the width of the collecting device while maintaining tension and alignment;
the guiding device and the collecting device are parallel to each other, and they rotate in the same direction at the same speed.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a schematic view of a method of producing an edible food product according to an embodiment of the invention.

FIG. 2a and FIG. 2b are illustrations of a system according to the invention.

FIG. 3 is a photograph of an edible food product.

Several aspects of the present invention are disclosed with reference to flow diagrams and/or block diagrams of methods, devices and systems.

On the figures, when present, the flow diagrams and/or block diagrams show the architecture, the functionality and possible implementation of devices or systems or methods, according to several embodiments of the invention.

In some implementations, the functions associated with the box may appear in a different order than indicated in the drawings. For example, two boxes successively shown, may be performed substantially simultaneously, or boxes may sometimes be performed in the reverse order, depending on the functionality involved.

### DETAILED DESCRIPTION

A description of example embodiments of the invention follows.

The expression “protein thread” as used herein can relate to a long, thin strand of material comprising at least 2% in weight of proteins, at least 5% in weight of proteins, preferably at least 10%, more preferably at least 15% in weight of proteins compared to the wet weight of the thread. A protein thread has a diameter of at least 0.01 mm, preferably at least 0.05 mm and an aspect ratio (length/diameter) of at least 100, preferably at least 200. Preferably the protein thread has a diameter of at most 2 mm, more preferably at most 1 mm, even more preferably at most 0.5 mm. The expression “edible protein thread” as used herein can relate to a protein thread suitable for animal consumption and preferably a protein thread suitable for human consumption.

The expressions “edible product” or “edible food product” as used herein can relate to a product suitable for animal consumption and preferably a product suitable for human consumption. An edible product according to the invention can be a ready to eat (i.e. finalized) food product or an intermediate in the production chain of a finalized food product. As it will be described hereafter, an edible product according to the invention can be produced in the form of a snack which may be pressed, fried and/or toasted; transformed meat-analogues or food specialty food such as sausage or cured sausage; a seafood; untransformed meat-analogues such as “flesh like” products.

In the following description, the term “meat” can refer to any edible part of an animal such as an animal tissue taken from a slaughtered animal. Hence, a meat can refer to liver or other offal tissues, fat tissues, muscle tissues conventionally found in an animal. The dead animal can refer to all species of the Animalia kingdom excluding human and preferably to all edible species such as a non-human vertebrate, for example, livestock, fish, bird; insect; a crustacean, for example a shrimp, prawn, crab, crayfish, and/or a lobster; a mollusk, for example an octopus, squid, cuttlefish, scallops, snail. Hence, for example, the invention allows the production of an edible product having meat-like texture such as a product mimicking marbled beef, tuna flesh or salmon flesh.

As used herein, the expression “in weight” is generally referring to the weight of a component compared to the weight of another component or of the whole composition, either the wet weight or the dry weight can be considered. Preferably, percentages are disclosed in reference to the wet weight.

As used herein, the expressions “cultivated cells” or “cultured cells” are used interchangeably. They can refer to cells multiplied and/or grown, preferably in a controlled environment, using a culture medium. It refers in particular to cells with a growth controlled by mankind, for example in an industrial process, as opposed to cells from conventional meat that have been multiplied in a living organism or cells grown in a natural environment (e.g. forest grown mushrooms). Cultivated cells can refer to cells belonging to Animalia kingdom for the proteins but also to Bacteria, Viridiplantae and Fungi kingdoms for example to provide additional proteins or fat. Cultivated cells can originate from cells of any origin such as cells from biopsies, from stem cells or correspond to stem cells themselves. More particularly, a cultivated cells-based protein thread can refer to a protein thread which is constituted mainly of proteins from cultivated cells. For example, a cultivated cells-based protein thread comprises at least 0.5% in weight of proteins from cultivated cells, preferably at least 1% in weight of proteins from cultivated cells, more preferably 2% in weight of proteins from cultivated cells, even more preferably 4% in weight of proteins from cultivated cells, compared to the total weight of proteins.

As used herein, the expression “extracts of cultivated cells” can refer to any fraction of disrupted cells or to any biological material purified or partially purified recovered from disrupted cells, such as cultivated cells protein extracts. Disrupted cells can be cells having partially or completely destroyed cell walls. In a protein thread, extracts of cultivated cells can comprise both disrupted cells and/or biological material recovered from disrupted cells. An extract of cultivated cells can for example be obtained by the separation and purification of the biological material recovered from disrupted cells. Hence, the extracts can for example be obtained after at least a drying step, a precipitation step or solvent extraction step. An intact cultivated animal cell can refer to cultivated animal cells with an intact cell wall as it can be evaluated by microscopy.

As used herein, the expression “texturizing molecule” can refer to one or several molecules which are capable of creating a heat-resistant thread. Preferably, a heat-resistant protein thread is formed when contacting the protein matrix with a coagulation bath, said protein matrix and/or coagulation bath comprising the one or several molecules capable of creating a heat-resistant thread.

As used herein, the term “polyelectrolyte” can refer to macromolecules that, when dissolved in a polar solvent like water, have a (large) number of charged groups covalently linked to them. In general, polyelectrolytes may have various kinds of such groups. Homogeneous polyelectrolytes have only one kind of charged group, e.g. only carboxylate groups.

As used herein, the expression “heat-resistant gel” can refer to a gel, for example formed from a polyelectrolyte and a polyvalent ion, which is not liquid at a temperature below 80° C. Preferably, it refers to a gel which is not liquid at a temperature below 100° C. As used herein, the expression “heat-resistant gel-forming polyelectrolyte” can refer to a polyelectrolyte which, when combined with a suitable polyvalent ion, will form a heat-resistant gel.

As used herein, “fatty matrix” can relate to a matrix suitable for human consumption. Preferably, a fatty matrix is constituted mainly of lipids. For example, a fatty matrix comprises at least 20% in weight of lipids, preferably at least 30% in weight of lipids, more preferably at least 40% in weight of lipids, more preferably 45% in weight of lipids, even more preferably 50% in weight of lipids.

As used herein, the expressions “fermentation obtained fat” or “fermented fat” can refer to lipid molecules produced in growth reactors for example through microbial fermentation. Lipid molecules obtained by fermentation can be chemically identical to fat produced by plants or animals.

As used herein, “protein matrix” can relate to a matrix, wet or dried, suitable for human consumption. Preferably, a protein matrix, when dried, is constituted mainly of protein. For example, a protein matrix comprises at least 50% in weight of protein, preferably at least 60% in weight of protein, more preferably 70% in weight of protein, even more preferably 80% in weight of protein with respect to a total dry weight of the protein matrix.

As used herein, the term “flavor” is generally the quality of the product that affects the sense of taste and/or the aroma. Hence, a “meat-like flavor” can refer to a flavor which is close to, or which approximates, the flavor of the related conventional meat product.

As used herein, the term “texture” can be considered as the “combination of the textural and structural (geometrical and surface) attributes of a food product perceptible by means of mechanical, tactile, and where appropriate, visual and auditory receptors” as defined in 2008 by the International Standards Organization (ISO, 2008, Sensory analysis-vocabular, Vols. 1-107, p. 5492). Hence, a “meat-like texture” can refer to the rheological and structural (geometrical and surface) attributes of a food product which is close to, or which approximates, the texture of the related conventional meat product (i.e. a meat product derived from animal slaughtering). An edible food product according to the invention with a meat-like texture and a meat-like flavor can be considered as an alternative to a meat product.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or even more. Hence, a composition with cells preserved substantially intact refers to a composition comprising at least about 50%, 60%, 70%, 80%, 90%, 95%, 96%, 97%, 98%, 99%, 99.5%, 99.9%, 99.99%, of intact cells.

As mentioned, the production of textured and tasty meat-like products without animal slaughtering, is a challenge for both animal welfare and the environment. In addition to animal welfare or environmental protection, it appears necessary to produce an edible food product which can correspond to the expectations of consumers by exhibiting qualities close to those of a conventional product and this with a reduced number of processing steps.

A new method has been developed for producing an edible food product comprising protein threads, which can have a meat-like appearance, texture and mouthfeel without comprising tissues from a slaughtered animal. Moreover, said protein threads can be associated with a fatty matrix in a continuous process so as to produce, in an highly efficient process, a structure that can mimic marbled meat. In particular, the answer which has been developed allows the scalable production of an edible food product that offers a gustative experience closer to the expected experience.

Hence, according to a first aspect, the invention relates to a method 100 of manufacturing an edible food product.

Particularly, the edible food product comprises protein threads and a fatty matrix.

The method 100 of manufacture according to the invention will preferably allow the production of an edible food product comprising edible protein threads which can have a meat-like texture.

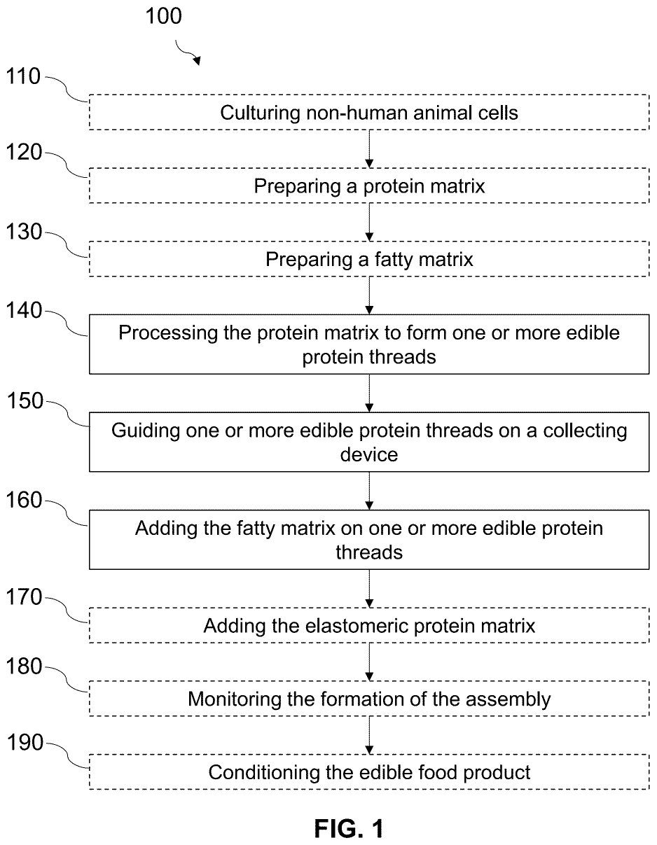

As illustrated in FIG. 1, the method comprises the steps of: processing 140 the protein matrix to form one or more edible protein threads, guiding 150 the one or more edible protein threads on a collecting device, and adding 160 the fatty matrix on the one or more edible protein threads.

An edible food product manufacturing method can comprise several other steps such as: blanching, heat sterilization, evaporation and distillation, dehydration, smoking, baking and roasting, frying, high pressure processing, Pulsed Electric Field (PEF) processing, ultrasound/cavitation/shock wave processing, pasteurization, application of cold plasma, dielectric, ohmic and infrared processing, microwave heating/blanching/assisted extraction, food irradiation, UV microbial inactivation, pulsed light technology, supercritical extractions, extrusion, freezing, chilling, modified atmospheres, drying technologies (freeze drying, membranes), fermentation, homogenization, mincing, grinding, chopping, salting, tumbling, curing, brine injection or injection of blood substitutes such as synthetic myoglobin or heme protein synthesized by fermentation or by microorganism. In particular, a method according to the invention can also comprise additional steps such as: culturing 110 non-human animal cells, preparing 120 a protein matrix, preparing 130 a fatty matrix, adding 170 an elastomeric protein matrix, monitoring 180 the formation of the assembly and/or conditioning 190 the edible food product.

As mentioned, an edible product can correspond to an ingredient for use in the preparation of a ready-to-eat food product such as an alternative to a meat product.

The edible food product according to the invention will preferably be a processed food product. Indeed, it will preferably result from a combination of edible substances from different organism sources (e.g. an hybrid product combining proteins from Animalia kingdom and fat from Plant kingdom, or combining proteins from Plant and/or Animalia and/or Fungi and/or Bacteria kingdoms and fat from Plant and/or Animalia and/or Fungi and/or Bacteria kingdoms).

As the conventional meat product, an edible food product according to the invention can comprise one or several separate matrices. At least, the edible food product according to the invention will comprise at least one protein matrix forming protein threads and at least one fatty matrix. A fatty matrix can be considered as a food matrix which contains a majority in weight of fat with respect to the total weight of the fatty matrix.

As shown in FIG. 1, a method according to the invention can comprise a step of culturing 110 non-human animal cells.

This step is in particular designed to generate an animal protein source without having to slaughter animals.

The animal cells can for example be selected from all non-human cells that can be found in usually bred, hunted or fished animals. Hence, the cultivated non-human animal cells can be selected among avian cells, bovine cells, seafood cells, porcine cells, or ovine cells. Throughout the text, when animal cells are mentioned in this document, they obviously refer to non-human animal cells.

Preferably, the animal cells are selected among cells from Animalia kingdom, in particular animal cells are selected among Mammalia cells, Aves cells, Actinopterygii cells, Malacostraca cells, Mollusca cells, and combination thereof.

For example, and in a non-limiting way, Mammalia cells can be Bovidae cells, Cervidae cells, Leporidae cells or Suidae cells; Aves cells can be Anatidae cells or Phasianidae cells; Actinopterygii cells can be Gadidae cells, Merlucciidae cells, Pleuronectidae cells, Salmonidae cells, or Scombridae cells; Malacostraca cells can be Palaemonidae cells and Mollusca cells can be Cephalopoda or Bivalvia cells.

Preferably, the non-human animal cells comprise Bovidae cells, Cervidae cells, Leporidae cells, Suidae cells, Anatidae cells, Phasianidae cells, Gadidae cells, Merlucciidae cells, Pleuronectidae cells, Salmonidae cells, Scombridae cells and/or Palaemonidae cells.

More preferably, the non-human animal cells comprise Bovidae cells, and/or Suidae cells, Anatidae cells, Phasianidae cells, Gadidae cells, Merlucciidae cells, Salmonidae cells, and/or Scombridae cells.

Even more preferably, the non-human animal cells comprise Bovidae cells, Suidae cells, Anatidae cells, Phasianidae cells, and/or Scombridae cells.

Whatever their origin, several types of cells can be used in this step of culturing 110.

For example, the non-human animal cells comprise cells selected among: stem cells such as embryonic stem cells, satellite cells, induced pluripotent stem cells, germ layers cells, fibro-adipogenic progenitors, muscle cells such as skeletal muscle cells, cardiac cells, or smooth muscle cells; myoblasts, myocytes, hepatocytes, fibrocytes, fibroblasts, adipocytes, chondrocytes, chondroblasts, keratinocytes, melanocytes, osteocytes, osteoblasts, Merkel cells, Langerhans cells, glial cells, Schwann cells, red blood cells (erythrocytes) and white blood cells, and combination thereof.

Preferably, the non-human animal cells comprise cells selected among: stem cells, muscle cells, fibroblasts, adipocytes, erythrocytes, and combination thereof.

There are many methods of culturing cells. These methods are often laboratory methods, but there are also many methods suitable for large volume production and human consumption. Hereafter we described some of the adapted methods for culturing non-human cells in the context of the invention.

During the step of culturing 110 non-human animal cells, cells can be either cultured in suspension or in adherence.

Advantageously, regardless of their origin, the cultivated non-human animal cells can be considered as cells grown in a culture medium. Advantageously, the culture medium does not comprise fetal bovine serum nor growth factors. The culture medium may be supplemented, preferably gradually, with hydrolysate as plant or yeast hydrolysate. Such serum free medium allows to reduce or eliminate need for animal derived components.

Various media formulations are optionally used to enable the maintenance of the capacity for self-renewal such as during expansion of the cell population. As explained, the media formulations may be modified from conventional media to not require fetal bovine serum or animal alternatives to bovine serum nor growth factors. Rather, the medium may include plant or yeast hydrolysates. Examples of plant-based formulations include soybean-based and plant hydrolysate-based media formulations. Some media formulations may further comprise at least one ingredient for enhancing the nutritional content of the cultured cells.

In addition, the medium comprises all the components and nutrients necessary to the development of cells such as salt, glucose, water, salt minerals, and amino acids.

In an embodiment, the culture medium may comprise scaffolds. The cells can be cultivated in incubators with a set up as e.g. temperature at 37° C., 5% of CO₂, at a pH of 7 and with moisture of at least 95%.

Also, the step of culturing 110 non-human animal cells can comprise a step of differentiating the cultivated cells. There are many methods of cell differentiation. These methods are often laboratory methods, but there are also many methods suitable for large volume production and human consumption. Hereafter, we described some of the adapted methods for differentiation of non-human cells in the context of the invention or using already differentiated cells. Cell differentiation may comprise production of particular proteins which contribute to the texture in a specific way more particularly related to a specific edible product.

### Differentiation of Non-Human Embryonic Stem Cells

Cells in the protein matrix may be derived from differentiation of non-human embryonic stem cells. The differentiation comprises the sum of the processes whereby undifferentiated or unspecialized cells attain their function. Stem cells can be isolated from embryos and cultured using specific cultured media in order to achieve cellular proliferation and maintenance of the undifferentiated state. This is particularly advantageous in order to reach a sufficient cell density or cell number. In an embodiment, the media formulations use synthetic serum-free media.

Next, the embryonic stem cells can be induced to differentiate for example into hepatocytes, fibroblasts, keratinocytes, myocytes or adipocytes. Differentiation can be triggered through the exposure to specific factors (e.g. growth factors or proteins) and/or culture condition (e.g. shear stress).

### Differentiation of Non-Human Induced Pluripotent Stem Cells.

Cells in the protein matrix may be derived from differentiation of non-human induced pluripotent stem cells.

An episomal reprogramming strategy, for example of avian dermal fibroblasts isolated from goose, duck or chicken, can be employed to create induced pluripotent stem cells from the fibroblasts without the use of classic viral reprogramming techniques.

The induced pluripotent stem cells can be cultured using optimized media substrates and media formulations to achieve persistent cellular proliferation and maintenance of the de-differentiated state. The media formulations preferably use synthetic serum-free media. Preferably, the cells are cultured in a pathogen-free cell culture system. Next, the pluripotent stem cells can be triggered to differentiate into a specific lineage as myocytes and expanded to a desired quantity of cells.

### Transdifferentiated Non-Human Isolated Cells.

Cells in the protein matrix may be derived from transdifferentiated non-human isolated cells. Transdifferentiation refers to the differentiation from one differentiated cell type to another differentiated cell type, preferably, in one step. Transdifferentiation can relates to a method that modifies the differentiated phenotype or developmental potential of a cell without the formation of a pluripotent intermediate cell; i.e. it does not require that the cell be first de-differentiated (or reprogrammed) and then differentiated to another cell type. Instead, the cell type is merely “switched” from one cell type to another without going through a less differentiated phenotype. Transdifferentiation may also comprise a first step of submitting first cells having a first cell fate to conditions to generate second cells (i.e., a less differentiated cells) that are capable of differentiating into a second cell fate; and a second step of submitting the less differentiated cells to conditions triggering differentiation into cells having the second cell fate, such as myocytes cells.

For example, non-human cells such as embryonic fibroblasts, embryonic stem cells, satellite cells or muscle cells are isolated using techniques known in the field of cell biology as exposed above and are cultivated in a medium comprising basal medium, antibiotics, non-essential amino acids, as well as reducing agents, serum, minerals and growth factors.

### Immortalized Mature Non-Human Myocytes or Hepatocytes.

Cells in the protein matrix may be selected from immortalized mature non-human differentiated cells. Cells can be immortalized using classical techniques such as transformation or spontaneous immortalization by sequentially passing the cells until spontaneous mutation that results in immortalization. For example, in the case of myocytes, the specificity of the immortalized mature non-human myocytes lies in the fact that cells are able to divide indefinitely. Mature avian myocytes can be isolated from duck, goose or chicken liver. The immortalized myocytes or hepatocytes can be expanded to a desired quantity of cells and grown in culture medium.

Differentiated Cells Derived from Differentiation of Non-Human Progenitor Cells.

Cells in the protein matrix may be selected from differentiated cells derived from non-human progenitor cells. The progenitor can be grown using optimized media substrates and media formulations in order to obtain a persistent cellular proliferation and maintenance of the pluripotent state. The media formulations may comprise synthetic serum-free media. In the case of satellite cells, they are induced to differentiate into mature skeletal muscle cells and expanded to a desired quantity of cells thanks to specific and well-known differentiation factors.

As shown in FIG. 1, a method 100 of manufacturing an edible food product according to the invention comprises a step of preparing a protein matrix 120. In particular, this step 120 can comprise a processing of the animal proteins.

The processing of the animal proteins is in particular designed to prepare the animal proteins, especially those produced during the culturing 110 step, so that they are suitable for the subsequent steps.

For example, the animal proteins used in the invention can be brought in the protein matrix within cultivated cells that have been kept intact. Alternatively, they may be brought in the protein matrix with cultivated cells that have been disrupted. Also, the animal proteins can be extracted from cultivated cells, for example disrupted cultivated cells.

Hence, after the step of culturing 110, the cultivated cells can be preserved substantially intact or they may have been substantially disrupted for example by homogenization, extrusion, mix, blending or melt blowing, electrospinning, centrifugal spinning, blow spinning.

When the cultivated cells have been disrupted, the method 100 according to the invention can comprise a step of extracting specific compounds after the disruption. For example, the method 100 according to the invention can comprise a step of extracting the proteins from the cultivated cells. Proteins can be purified or can be segregated in protein fractions according to specific physicochemical properties.

The preparation of the protein matrix 120 is in particular designed to define the main constituent of the protein thread and its mechanical and organoleptic properties. Hence, such a step 120 contributes to the resolution of the problems solved by the invention.

The dry content of the protein matrix can have a marked influence on the mechanical properties of the protein threads obtained with said protein matrix. Hence, preferably the protein matrix has a dry content of at least 12 wt %. Preferably, the protein matrix has a dry content of at least 15 wt %, more preferably a dry content of at least 20 wt %. For example, the protein matrix has a dry content of at most 90 wt %. Preferably, the protein matrix has a dry content of at most 85 wt %, more preferably a dry content of at most 80 wt %.

Also, since this matrix is the basis for the constitution of protein threads, it preferably includes a significant amount of proteins. Hence, the protein matrix can comprise at least 5% in weight of proteins compared to the total wet weight of the protein matrix. Preferably, the protein matrix can comprise at least 10% in weight of proteins compared to the total wet weight of the protein matrix. Preferably, the protein matrix can comprise at least 15% in weight of proteins compared to the total wet weight of the protein matrix, more preferably at least 20% in weight, even more preferably at least 25% in weight, compared to the total wet weight of the protein matrix. The protein matrix can comprise at most 40% in weight of proteins compared to the total wet weight of the protein matrix. Preferably, the protein matrix can comprise at most 38% in weight of proteins compared to the total wet weight of the protein matrix, more preferably at most 35% in weight, even more preferably at most 30% in weight, compared to the total wet weight of the protein matrix. Hence, the protein matrix can comprise from 5% to 40% in weight of proteins compared to the total wet weight of the protein matrix for example from 10% to 40%. Preferably, the protein matrix can comprise from 15% to 38% in weight of proteins compared to the total wet weight of the protein matrix, more preferably from 20% to 35%, even more preferably from 25% to 30% in weight.

In the protein matrix, said proteins can be for example plant proteins, microbial proteins, algae proteins, animal proteins, fungal proteins, and a combination thereof.

In particular, the animal proteins are animal proteins from non-human cultivated animal cells. Hence, notably, the protein matrix comprises animal proteins which have been obtained from non-human cultivated animal cells.

### Animal Proteins

In contrast to the conventional method of producing meat edible products, the animal proteins used here are not proteins produced from a slaughtered animal, but proteins produced by non-human animal cells grown in a cell culture facility. When animal proteins are mentioned in this document, they are obviously non-human animal proteins.

As it has been described, the animal proteins can be brought in the protein matrix in the form of intact or disrupted cultivated cells or also in the form of proteins extracted from cultivated cells.

Hence, the step of preparing a protein matrix 120 can comprise an addition of cultivated cell extracts, disrupted cultivated cells and/or intact cultivated cells. More preferably, the protein matrix comprises food-grade non-human animal cells (intact or disrupted) harvested from a cell culture (in suspension or in adherence, preferably in suspension), or extracts of said cells, preferably protein extracts of said cells.

Preferably, the protein matrix comprises cultivated non-human animal cells. The cultivated non-human animal cells can comprise disrupted cultivated cells and/or intact cultivated cells.

In particular, the protein matrix can comprise at least 1% in dry weight of cultivated non-human animal cells compared to the total wet weight of the protein matrix. Preferably, before the processing 140 step, the protein matrix can comprise at least 2% in dry weight of cultivated non-human animal cells compared to the total wet weight of the protein matrix, more preferably at least 4% in dry weight, even more preferably at least 8% in dry weight, compared to the total wet weight of the protein matrix.

In particular, the protein matrix can comprise at most 30% in dry weight of cultivated non-human animal cells compared to the total wet weight of the protein matrix. Preferably, before the processing 140 step, the protein matrix can comprise at most 28% in dry weight of cultivated non-human animal cells compared to the total wet weight of the protein matrix, more preferably at most 25% in dry weight, even more preferably at most 22% in dry weight, compared to the total wet weight of the protein matrix.

In particular, the protein matrix can comprise cultivated non-human animal cells from 1% to 30% in dry weight compared to the total wet weight of the protein matrix. Preferably, the protein matrix can comprise cultivated non-human animal cells from 2% to 28% in dry weight compared to the total wet weight of the protein matrix, more preferably from 4% to 25% in dry weight, even more preferably from 8% to 22% in dry weight, compared to the total wet weight of the protein matrix.

The quantity of cultivated non-human animal cells can be measured after harvesting and centrifugation and corrected based on the moisture content. The moisture content can be measured according to the international norm ISO 1442:1997. When implementing a method of producing an edible product or ingredient, the origin of the ingredient is generally known. Hence, the person skilled in the art will be able to know if he is adding proteins that are either animal proteins being from non-human cultivated animal cells or not. An animal protein being from non-human cultivated animal cells is for example a protein produced by a non-human animal cell which is grown in a bioreactor or fermentation reactor.

In particular, the protein matrix can comprise at least 1% in dry weight of cultivated non-human animal cell extracts compared to the total wet weight of the protein matrix. Preferably, before the processing 140 step, the protein matrix can comprise at least 2% in dry weight of cultivated non-human animal cell extracts compared to the total wet weight of the protein matrix, more preferably at least 4% in dry weight, even more preferably at least 8% in dry weight, compared to the total wet weight of the protein matrix.

In particular, the protein matrix can comprise at most 30% in dry weight of cultivated non-human animal cell extracts compared to the total wet weight of the protein matrix. Preferably, before the processing 140 step, the protein matrix can comprise at most 28% in dry weight of cultivated non-human animal cell extracts compared to the total wet weight of the protein matrix, more preferably at most 25% in dry weight, even more preferably at most 22% in dry weight, compared to the total wet weight of the protein matrix.

In particular, the protein matrix can comprise cultivated non-human animal cell extracts from 1% to 30% in dry weight compared to the total wet weight of the protein matrix. Preferably, before the processing 140 step, the protein matrix can comprise cultivated non-human animal cell extracts in an amount that is from 2% to 28% in dry weight compared to the total wet weight of the protein matrix, more preferably from 4% to 25% in dry weight, even more preferably from 8% to 22% in dry weight, compared to the total wet weight of the protein matrix.

The concentration of proteins, and in particular animal proteins, in the protein matrix can affect the texture of the protein thread.

The protein matrix can comprise at least 0.5% in weight of animal proteins being from non-human cultivated animal cells compared to the total wet weight of the protein matrix. Preferably, the protein matrix can comprise at least 1% in weight of animal proteins being from non-human cultivated animal cells compared to the total wet weight of the protein matrix, more preferably at least 2% in weight, even more preferably at least 4% in weight, compared to the total wet weight of the protein matrix.

The protein matrix can comprise at most 30% in weight of animal proteins being from non-human cultivated animal cells compared to the total wet weight of the protein matrix. Preferably, the protein matrix can comprise at most 28% in weight of animal proteins being from non-human cultivated animal cells compared to the total wet weight of the protein matrix, more preferably at most 25% in weight, even more preferably at most 22% in weight, compared to the total wet weight of the protein matrix.

Hence, the protein matrix can comprise from 0.5% to 30% in weight of animal proteins being from non-human cultivated animal cells compared to the total wet weight of the protein matrix. Preferably, the protein matrix can comprise from 1% to 28% in weight of animal proteins being from non-human cultivated animal cells compared to the total wet weight of the protein matrix, more preferably from 2% to 25%, even more preferably from 4% to 22% in weight, compared to the total wet weight of the protein matrix.

The protein matrix can comprise at least 5% in weight of animal proteins being from non-human cultivated animal cells compared to the total weight of proteins in the protein matrix. Preferably, the protein matrix can comprise at least 10% in weight of animal proteins being from non-human cultivated animal cells compared to the total weight of proteins in the protein matrix, more preferably at least 20% in weight, even more preferably at least 30% in weight, at least 40% in weight, at least 50% in weight, at least 60% in weight, compared to the total weight of proteins in the protein matrix.

The protein matrix can comprise at most 100% in weight of animal proteins being from non-human cultivated animal cells compared to the total weight of proteins in the protein matrix. Preferably, the protein matrix can comprise at most 90% in weight of animal proteins being from non-human cultivated animal cells compared to the total weight of proteins in the protein matrix, more preferably at most 80% in weigh compared to the total weight of proteins in the protein matrix.

Hence, the protein matrix can comprise from 5% to 100% in weight of animal proteins being from non-human cultivated animal cells compared to the total weight of proteins in the protein matrix. Preferably, the protein matrix can comprise from 10% to 100% in weight of animal proteins being from non-human cultivated animal cells compared to the total weight of proteins in the protein matrix, more preferably from 20% to 100%, even more preferably from 30% to 100% in weight, from 40% to 90% in weight, from 50% to 100% in weight, from 50% to 90% in weight, compared to the total weight of proteins in the protein matrix.

Preferably, the quantity of animal proteins can be measured using Kjeldahl titration according to the international norm ISO 937:1978. When implementing a method of producing an edible product or ingredient, the origin of the ingredient is generally known. Hence, the person skilled in the art implementing the invention will be able to know if he is adding proteins that are either animal proteins being from non-human cultivated animal cells or not.

In the context of the present invention, the presence of specific molecules, in particular proteins, can be of utmost importance to improve the final protein thread quality. The quantity of specific molecules, in particular proteins, can be measured by well-known techniques by the person skilled in the art such as enzyme-linked immunosorbent assay or mass spectrometry. For example, the animal proteins can comprise heat shock proteins.

Preferably, the animal proteins comprise myofibrillar proteins. For example, the myofibrillar proteins can comprise actin, myosin, tropomyosin, troponin, actinin, connectin, titin, nebulin, C protein, M proteins, desmin or a combination thereof.

Preferably, the myofibrillar proteins are selected among: actin, desmin, myosin, troponin, titin, nebulin or a combination thereof. More preferably, the myofibrillar proteins are selected among: actin, desmin, myosin, troponin or a combination thereof. Even more preferably, the myofibrillar proteins are selected among: actin, myosin or a combination thereof.

The protein matrix can comprise at least 0.25% in weight of myofibrillar proteins compared to the total weight of proteins, preferably at least 0.5% in weight of myofibrillar proteins, more preferably at least 1% in weight of myofibrillar proteins, even more preferably at least 2% in weight of myofibrillar proteins compared to the total weight of proteins.

The protein matrix can comprise at most 70% in weight of myofibrillar proteins compared to the total weight of proteins, preferably at most 60% in weight of myofibrillar proteins, more preferably at most 50% in weight of myofibrillar proteins, even more preferably at most 40% in weight of myofibrillar proteins compared to the total weight of proteins.

Hence, the protein matrix can comprise between 0.25% and 70% in weight of myofibrillar proteins compared to the total weight of proteins, preferably between 0.5% and 60% in weight of myofibrillar proteins, more preferably between 1% and 50% in weight of myofibrillar proteins, even more preferably between 2% and 40% in weight of myofibrillar proteins compared to the total weight of proteins.

In particular, the protein matrix can advantageously comprise specific myofibrillar proteins. For example, the protein matrix can comprise troponin protein preferably at least 0.0125% in weight of troponin protein compared to the total weight of proteins in the protein matrix, preferably at least 0.025% in weight, more preferably at least 0.05% in weight, even more preferably at least 0.1% in weight, compared to the total weight of proteins in the protein matrix.

The protein matrix can comprise at most 3.5% in weight of troponin protein compared to the total weight of proteins in the protein matrix, preferably at most 3% in weight, more preferably at most 2.5% in weight, even more preferably at most 2% in weight, compared to the total weight of proteins in the protein matrix.

Hence, the protein matrix can comprise from 0.0125 to 3.5% in weight of troponin protein compared to the total weight of proteins in the protein matrix, preferably from 0.025 to 3% in weight, more preferably from 0.05 to 2.5% in weight; even more preferably from 0.1 to 2% in weight, compared to the total weight of proteins in the protein matrix.

The troponin can be produced by a cultivated animal cell. However, it can also be a recombinant troponin that can be produced by a cultivated cell which can be a plant cell, an insect cell or a microbial cell.

In the context of the present invention, the presence of some specific molecules can improve the produced protein thread. In particular, the presence of extracellular matrix animal molecules (ECM) such as ECM polysaccharides, ECM proteoglycans or ECM proteins, can improve the produced protein thread. ECM proteins are particularly preferred. For example, the protein matrix can comprise at least 0.1% in weight of extracellular matrix animal molecules compared to the total weight of proteins. Preferably, it comprises at least 0.5% in weight of extracellular matrix animal molecules compared to the total weight of proteins, more preferably at least 1% in weight, even more preferably at least 1.5% in weight of extracellular matrix animal molecules compared to the total weight of proteins. When the protein matrix comprises several extracellular matrix animal molecules the concentrations are cumulated to evaluate the quantity of extracellular matrix animal molecules in the protein matrix.

Such molecules can be added in the protein matrix through cultivated cells, preferably cultivated animal cells, such as fibroblasts, known to produce such molecules.

The protein matrix can comprise collagen, preferably at least 1% in weight of collagen compared to the total weight of proteins in the protein matrix, preferably at least 2% in weight, more preferably at least 3% in weight, even more preferably at least 4% in weight, compared to the total weight of proteins in the protein matrix.

The protein matrix can comprise at most 16% in weight of collagen compared to the total weight of proteins in the protein matrix, preferably at most 14%, more preferably at most 12%, even more preferably at most 10% in weight, compared to the total weight of proteins in the protein matrix.

Hence, the protein matrix can comprise from 1 to 16% in weight of collagen compared to the total weight of proteins in the protein matrix, preferably from 2 to 14% in weight, more preferably from 3 to 12% in weight; even more preferably from 4 to 10% in weight, compared to the total weight of proteins in the protein matrix.

The collagen can be a collagen produced by a cultivated animal cell. However, it can also be a recombinant collagen that can be produced by a cultivated cell which can be a plant cell, an insect cell or a microbial cell.

The protein matrix can comprise elastin and/or tropoelastin, preferably at least 0.065% in weight of elastin and/or tropoelastin compared to the total weight of proteins in the protein matrix, preferably at least 0.13% in weight, more preferably at least 0.2% in weight, even more preferably at least 0.25% in weight, compared to the total weight of proteins in the protein matrix.

The protein matrix can comprise at most 7.5% in weight of elastin and/or tropoelastin compared to the total weight of proteins in the protein matrix, preferably at most 7% in weight, more preferably at most 6.5% in weight, even more preferably at most 6% in weight, compared to the total weight of proteins in the protein matrix.

Hence, the protein matrix can comprise from 0.065 to 7.5% in weight of elastin and/or tropoelastin compared to the total weight of proteins in the protein matrix, preferably from 0.13 to 7% in weight, more preferably from 0.2 to 6.5% in weight; even more preferably from 0.25 to 6% in weight, compared to the total weight of proteins in the protein matrix.

Preferably, said elastin and/or tropoelastin are produced by a cultivated animal cell. However, it can also be a recombinant elastin and/or tropoelastin that can be produced by a cultivated cell which can be a plant cell, an insect cell or a microbial cell, elastin and/or tropoelastin being preferably in a soluble form.

As it has been described, in a preferred embodiment the protein matrix comprises animal proteins being from non-human cultivated animal cells. However, the protein matrix can comprise proteins from other origins.

In particular, the step of preparation of a protein matrix 120 can comprise the addition of non-animal proteins such as plant proteins, microbial proteins, algae proteins and/or fungal proteins. Adding some non-animal proteins can be used to tune the viscoelasticity or flow properties of the protein matrix comprising non-human animal cultivated cells.

In a particular embodiment, the protein matrix further comprises plant proteins, preferably the plant proteins can be selected among: sunflower proteins, soybeans proteins, pea proteins, canola proteins, mung bean proteins, chickpea proteins, faba bean proteins, lentils proteins, seaweed proteins, potato proteins, quinoa proteins, nuts proteins, wheat proteins, winged bean proteins, bambara bean proteins, dulse proteins, mesquite bean proteins, duckweed proteins, dry broad bean proteins, dry cow pea proteins, lupins proteins, jackfruit proteins, amaranth proteins, millet proteins, oat proteins, chia proteins, aquafaba proteins, hemp seed proteins and rice proteins or a combination thereof.

Preferably, the step of preparation of a protein matrix 120 can comprise the addition of non-animal proteins from at least two different sources. For example, the protein matrix comprises plant proteins from at least two different plants. Indeed, a combination of several origins allows an improvement of the properties of the edible protein threads and the establishment of an amino acid profile optimized for human nutrition. More preferably the step of preparation of a protein matrix 120 can comprise the addition of pulse proteins and cereal proteins.

As shown in FIG. 1, a method 100 of manufacturing an edible food product according to the invention comprises a step of preparing a fatty matrix 130.

The content of the fatty matrix can have a marked influence on the experience of the product taster. This step 130 is particularly thus designed to prepare a fatty matrix that is complementary to the protein matrix to form an edible food product with the expected texture when combining the two matrices. Hence, such a step 130 contributes to the resolution of the problems solved by the invention.

The fatty matrix preparation can comprise the addition of fat which is, at 20° C., in a solid state, a liquid state and/or a semi-solid state. Preferably, the fatty matrix preparation comprises the addition of fat which is in a solid state at 20° C. In an embodiment, the fatty matrix preparation comprises the addition of at least 10% of fat which is in a solid state at 20° C.

The fatty matrix comprises at least 20% in weight of fat, in particular at least 20% in weight of plant fat and/or fermented fat, compared to the total weight of the fatty matrix. For example, the fatty matrix comprises at least 30% in weight of fat, in particular at least 30% in weight of plant fat and/or fermented fat, compared to the total weight of the fatty matrix.

In particular, the fatty matrix comprises at least 40% of plant fat and/or fermented fat in weight with respect to a total wet weight of fatty matrix. For example, the fatty matrix can comprise at least 50% of plant fat and/or fermented fat in weight with respect to a total weight of fatty matrix. Preferably, the fatty matrix comprises at least 55%, more preferably at least 60%, even more preferably at least 65%, such as at least 70% of plant fat and/or fermented fat in weight with respect to a total weight of fatty matrix (e.g. wet weight). It should be understood that when the fatty matrix contains plant fat and fermented fat, then the percentages mentioned above refer to the combined percentages in weight of plant and fermented fat. Preferably said fat is a plant fat or a mixture of fat from different plants.

However, as will be specified later, the fatty phase does not only include plant fat and/or fermented fat. It can include fat of other origins and ingredients other than fat. Hence, the fatty matrix can comprise at most 95% of plant fat and/or fermented fat in weight with respect to a total weight of fatty matrix. Preferably, the fatty matrix comprises at most 90%, more preferably at most 85%, even more preferably at most 80%, of plant fat and/or fermented fat in weight with respect to a total weight of fatty matrix (e.g. wet weight).

The fatty matrix according to the invention can be characterized by its ability to adequately mimic the properties of the conventional fat from meat. In particular, as it will be mentioned in the example section, the fatty matrix can have a hardness at cooking temperature which is substantially equal to the hardness of the lipid phase of conventional meat at this cooking temperature.

Preferably, the fatty matrix comprises a liquid fat and/or a solid fat. Preferably, the fatty matrix comprises a combination of liquid fat and a solid fat, at 20° C. More preferably, the fatty matrix can have a solid fat content of at least 0.1%, for example at least 0.5%, preferably at least 2%, more preferably at least 5%, even more preferably at least 10% at 20° C. as measured according to the norm ISO 8292-2:2008 and with respect to the total weight of fat in the fatty matrix. The fatty matrix can have a solid fat content of at most 45%, preferably at most 40%, more preferably at most 35%, even more preferably at most 30% at 20° C. as measured according to the norm ISO 8292-2:2008 and with respect to the total weight of fat in the fatty matrix.

In some embodiment, the fatty matrix can have a solid fat content ranging from 0.1% to 45%, for example from 0.5% to 45%, preferably 2% to 40%, more preferably 5% to 35%, even more preferably at least 10% to 30% at 20° C. as measured according to the norm ISO 8292-2:2008 and with respect to the total weight of fat in the fatty matrix.

In some embodiment, the fatty matrix can have a solid fat content ranging from 0.1% to 8%, preferably 0.25% to 6%, more preferably 0.5% to 4%, even more preferably at least 0.75% to 2.5% at 20° C. as measured according to the norm ISO 8292-2:2008 and with respect to the total weight of fat in the fatty matrix.

Preferably, most of the plant fat and/or fermented fat found in the fatty matrix are present in the form of triglycerides. Hence, the fatty matrix can comprise at least 50% in weight of triglycerides with respect to a total weight of fat in the fatty matrix, preferably at least 70% in weight of triglycerides with respect to a total weight of fat in the fatty matrix, more preferably at least 80% in weight of triglycerides with respect to a total weight of fat in the fatty matrix, even more preferably at least 90% such as at least 95% in weight of fats are triglycerides with respect to a total weight of fat in the fatty matrix. In an embodiment, these triglycerides can come from the plant and/or fermented fat but also from cultivated cells added to the fatty matrix.

In particular, the triglycerides of the fatty matrix can comprise more than 40% in weight of unsaturated C18 fatty acids with less than four carbon-carbon double bonds with respect to the total weight of triglycerides in the fatty matrix. Preferably, the triglycerides of the fatty matrix comprise more than 45% in weight of unsaturated C18 fatty acids with less than four carbon-carbon double bonds with respect to the total weight of triglycerides in the fatty matrix. More preferably, the triglycerides of the fatty matrix comprise more than 50% in weight of unsaturated C18 fatty acids with less than four carbon-carbon double bonds with respect to the total weight of triglycerides of the fatty matrix. Even more preferably, the triglycerides comprise more than 55% in weight of unsaturated C18 fatty acids with less than four carbon-carbon double bonds with respect to the total weight of triglycerides in the fatty matrix. As detailed in the examples, the edible food product of the invention can also comprise a minimal concentration of polyunsaturated C18 fatty acids, preferably in the form of triglycerides. Hence, in particular, as it will be shown in examples, the triglycerides of the fatty matrix comprise more than 1.5% in weight of polyunsaturated C18 fatty acids with respect to the total weight of triglycerides in the fatty matrix. Preferably, the triglycerides of the fatty matrix comprise more than 2% in weight of polyunsaturated C18 fatty acids with respect to the total weight of triglycerides in the fatty matrix. Preferably, the triglycerides of the fatty matrix comprise more than 2.5% in weight of polyunsaturated C18 fatty acids with respect to the total weight of triglycerides in the fatty matrix. More preferably, the triglycerides of the fatty matrix comprise more than 3.5% in weight of polyunsaturated C18 fatty acids with respect to the total weight of triglycerides of the fatty matrix. Even more preferably, the triglycerides comprise at least 7% in weight of polyunsaturated C18 fatty acids with respect to the total weight of triglycerides in the fatty matrix.

It has been found that presence of stearic acid in the triglycerides can be beneficial to the needs solved by the invention. Hence, in particular, as it is illustrated in examples, the triglycerides of the fatty matrix can comprise at least 4% in weight of stearic acid with respect to the total weight of triglycerides in the fatty matrix. Preferably, the triglycerides of the fatty matrix comprise at least 5% in weight of stearic acid with respect to the total weight of triglycerides in the fatty matrix. More preferably, the triglycerides of the fatty matrix comprise at least 10% in weight of stearic acid with respect to the total weight of triglycerides of the fatty matrix. Even more preferably, the triglycerides comprise at least 15% in weight of stearic acid with respect to the total weight of triglycerides in the fatty matrix. However, an excessive portion of stearic acid in the triglycerides of the fatty matrix can be detrimental to the needs solved by the invention. In preferred embodiments, the triglycerides of the fatty matrix comprise less than 40% in weight of stearic acid with respect to the total weight of triglycerides in the fatty matrix. Preferably, the triglycerides of the fatty matrix comprise more than 30% in weight of stearic acid with respect to the total weight of triglycerides in the fatty matrix. More preferably, the triglycerides of the fatty matrix comprise more than 20% in weight of stearic acid with respect to the total weight of triglycerides of the fatty matrix. Similarly, it has been discovered that an excessive portion of palmitic acid in the triglycerides of the fatty matrix can be detrimental to the needs solved by the invention. Hence, in particular, as it is shown in examples, the triglycerides of the fatty matrix comprise less than 59.00% in weight of palmitic acid with respect to the total weight of triglycerides in the fatty matrix. Preferably, the triglycerides of the fatty matrix comprise less than 50% in weight of palmitic acid with respect to the total weight of triglycerides in the fatty matrix. More preferably, the triglycerides of the fatty matrix comprise less than 40% in weight of palmitic acid with respect to the total weight of triglycerides in the fatty matrix. Even more preferably, the triglycerides of the fatty matrix comprise at most 35.00% in weight of palmitic acid with respect to the total weight of triglycerides in the fatty matrix.

The fatty matrix can only comprise plant fat or can only comprise fermented fat or can comprise a combination of plant fat and fermented fat. Moreover, the plant fat and/or fermented fat can be completed with other fats. Indeed, as the fatty matrix can comprise proteins such as animal proteins which can come from animal cultured cells, the fatty matrix can comprise animal cell triglycerides. Preferably the fats of the fatty matrix are mainly selected from plant fat and/or fermented fat. Also, the fats of the fatty matrix can be obtained from fractionated oil and/or hydrogenated oil and/or deodorized oil and/or interesterified oil.

The plant fat can for example comprise fat or oil extracted from edible plant matter, including the flowers, fruits, stems, leaves, roots, germs and seeds. Preferably, the plant fat can for example comprise fat or oil extracted from oilseeds or fruits. In particular, the plant fat can relate to fat extracted from canola seed (rapeseed), castor, coconut, flaxseed, allanblackia, olive, sunflower, soybean, peanut, illipe, cottonseed, shea, palm, avocado, safflower, sesame, lemon, grapeseed, macadamia, almond, sal, kokum, or mango or a combination thereof.

In particular, the plant fat used according to the invention can be selected from olive oil, palm oil, avocado oil, almond oil or combination thereof.

The fermented fat can comprise fat or oil extracted from cells cultivated in anaerobic or aerobic fermentation process, in particular process involving cultivation of oleaginous microorganisms or animal cells excluding human cells. For example, the fermented fat can include fat from cyanobacteria, microalgae, yeast, fungi such as filamentous fungi, bacteria or cultivated animal cells excluding human cells, such as adipocytes. Preferably, the fermented fat comprises fat or oil extracted from oleaginous yeast, such as Rhodosporidium toruloides, Lipomyces starkeyi and Yarrowia lipolytica.

Moreover, beside the presence of fat, the fatty matrix according to the invention advantageously can comprise polysaccharides. Said polysaccharides in the fatty matrix could be polysaccharides derived from seaweed, plant tissues, microbial fermentation, animal tissues, chemical synthesis, and a combination thereof.

The fatty matrix can preferably further comprise at least one polysaccharide selected from the group consisting of agar; alginates; carrageenans such as kappa carrageenan or iota carrageenan; gelatin; dextran; starch; gellan gum; guar gum; arabic gum; konjac; cellulose derivatives, such as methylcellulose and carboxymethylcellulose; pectin; pullulan; tara gum; xanthan gum; and combination thereof.

Moreover, beside the presence of fat, the fatty matrix according to the invention advantageously can comprise proteins. Said proteins of the fatty matrix could be non-human animal proteins, plant proteins, microbial proteins, algae proteins and/or fungal proteins, and a combination thereof.

In a particular embodiment, proteins are animal proteins excluding human proteins also called non-human animal proteins. Indeed, without being limited by the theory, the presence of proteins, in particular animal proteins, improves the ability of the fatty matrix to respond to the identified needs. For example, the inventors formulated the hypothesis that, in the specific fatty matrix of the invention, the proteins help in combination with a specific fat composition to produce a suitable mouthfeel, similar to the meat texture and in particular the fat phase texture of the meat. Moreover, the presence of proteins in the fatty matrix contributes to limiting the additives present in the food matrix. Moreover, the presence of animal proteins, preferably from non-human cultivated animal cells or extracts of said cells, improves the organoleptic properties of the fatty matrix, especially the flavor.

Hence, as it is illustrated in examples, the fatty matrix can further comprise at least 0.25% of proteins in weight with respect to the total weight of fatty matrix (e.g. wet weight). Preferably, the fatty matrix further comprises at least 0.50% of proteins in weight with respect to the total weight of the fatty matrix. More preferably, the fatty matrix further comprises at least 1% of proteins in weight with respect to the total weight of the fatty matrix. Even more preferably, the fatty matrix further comprises at least 1.5% of proteins in weight with respect to the total weight of fatty matrix (e.g. wet weight). These proteins can be plant proteins, fungal proteins, bacterial proteins, fermented proteins, recombinant proteins, non-human animal proteins and a mixture thereof. Advantageously said proteins include non-human animal proteins. In an even preferred embodiment, said non-human animal proteins being from non-human cultivated animal cells or extracts of said cultivated cells. Thus, at least 0.25% of proteins in weight with respect to the total weight of fatty matrix can be non-human animal proteins, preferably from non-human cultivated animal cells or extracts of said cells, advantageously improving the flavor of the edible food product according to the invention.

Hence, the fatty matrix can further comprise at least 0.25% in weight of non-human animal proteins with respect to the total wet weight of the fatty matrix, preferably at least 0.5% of non-human animal proteins in weight with respect to the total weight of the fatty matrix (e.g. wet weight). More preferably, the fatty matrix further comprises at least 1.0% of non-human animal proteins in weight with respect to the total weight of the fatty matrix. Even more preferably, the fatty matrix further comprises at least 1.5% of non-human animal proteins in weight with respect to the total weight of the fatty matrix (e.g. wet weight). Preferably, said non-human animal proteins being from non-human cultivated animal cells or extracts of said cells.

However, the fatty matrix preferably should not comprise a high quantity of proteins and in particular non-human animal proteins. Hence, the fatty matrix can comprise less than 20% of proteins in weight with respect to the total weight of the fatty matrix. Preferably, the fatty matrix comprises less than 18% of proteins in weight with respect to the total weight of the fatty matrix. More preferably, the fatty matrix further comprises less than 16% of proteins in weight with respect to the total weight of the fatty matrix. Even more preferably, the fatty matrix further comprises less than 14% of proteins in weight with respect to the total weight of the fatty matrix (e.g. wet weight). Among these proteins, the fatty matrix can comprise less than 16%, less than 14%, less than 12%, less than 10% of non-human animal proteins in weight with respect to the total weight of the fatty matrix (e.g. wet weight). Preferably, said non-human animal proteins being from non-human cultivated animal cells or extracts of said cells.

Preferably, the fatty matrix further comprises from 0.25% to 20% in weight of proteins with respect to the total weight of fatty matrix. More preferably, the fatty matrix further comprises from 0.5% to 18% in weight of proteins with respect to the total weight of fatty matrix. Even more preferably, the fatty matrix further comprises from 1% to 16% in weight of proteins with respect to the total weight of fatty matrix (e.g. wet weight). Among these proteins, the fatty matrix can comprise from 0.25% to 16%, from 0.5% to 14%, from 1% to 12%, or from 1.5% to 10%, of non-human animal proteins in weight with respect to the total weight of the fatty matrix. Preferably, said non-human animal proteins being from non-human cultivated animal cells or extracts of said cells.

Non-human animal cells, non-human animal proteins and animal proteins from cultivated non-human animal cells and extracts of said cells have already been described, for example when describing the step of culturing 110 non-human animal cells. Hence, all embodiments related to non-human animal cells, non-human animal proteins and animal proteins from cultivated non-human animal cells and extracts of said cells described here before, preferred or not preferred, are applicable to the non-human animal protein that can be found in the fatty matrix. In particular non-human animal proteins can be selected among Bovidae proteins, Aves proteins, Suidae proteins, Leporidae proteins, Actinopterygii proteins, and combination thereof. More preferably, the non-human animal proteins are selected among duck proteins, goose proteins, chicken proteins, beef proteins, pork proteins, tuna proteins, salmon proteins and combination thereof.

In an embodiment, the animal proteins of the fatty matrix can be derived from cultured animal cells, excluding human cells. For those who do not understand this meaning, the person skilled in the art knows that a beef protein is a protein produced by a beef cell, said beef cell may be cultured outside the beef organism. For example, a beef cell belongs or is from an organism which belongs, by its ancestors, to a kingdom (Animalia), a phylum (Chordata), a class (Mammalia), an order (Artiodactyla), a family (Bovidae) and to a genus (Bos). For example it can belong to species such as Bos taurus.

The protein matrix or the fatty matrix can further comprise a cross-linking molecule such as peptidase, α-galactosidase, alcalase, thermolysin, pepsin, tripsin, chymotrypsin, asparaginase, elastase, subtilisin, glucose oxidase, laccase, transglutaminase, pectin esterase, sortase, tyrosinase, oxidoreductase such as lysyl oxidase and peroxidase, genipin, riboflavin, monoamine oxidase or a combination thereof, preferably further comprises laccase, transglutaminase or a combination thereof. Such molecules can act as a natural cross-linking molecule and help to modulate physical properties of protein threads and the fatty matrix.

As shown in FIG. 1, a method according to the invention can comprise a step of preparing an elastomeric protein matrix.

This step is in particular designed to generate an optional constituent of the edible food product implicated in its mechanical and organoleptic properties. Such a step contributes to the resolution of the problems solved by the invention. In particular, as it is illustrated in the example, the use of an elastomeric protein matrix can improve the fiber-fiber and fiber-fat attachment and enhances the juiciness of the edible food product.

The elastomeric protein matrix comprises at least one elastomeric protein.

An elastomeric protein is a protein which can undergo an elastic deformation where the energy used for the deformation can be recovered after removal of the applied force. In particular, an elastomeric protein can correspond to a protein formed from multiple monomers, such as elastin which is formed from multiple tropoelastin monomers.

An elastomeric protein has for example a high elasticity and thus a low Young's modulus. For example, an elastomeric protein according to the invention has a Young's modulus under 10 GPa. Preferably, an elastomeric protein according to the invention has a Young's modulus under 1 GPa, more preferably under 500 MPa, and even more preferably under 10 MPa. The Young's moduli of these elastomeric proteins can be obtained through direct measurement of force under stretching, mostly using atomic force spectroscopy (AFM).

Preferably, the elastomeric protein comprises collagen, gelatin, elastin, resilin, wheat gluten, glutelins such as glutenin prolamins such as gliadin, abductin, flagelliform silk, casein and combination thereof. More preferably, the elastomeric protein comprises collagen, elastin, resilin, abductin, glutenin, gliadin and combination thereof. Even more preferably, the elastomeric protein comprises collagen, elastin, and combination thereof.

More preferably, the elastomeric protein comprises extracellular matrix non-human animal molecules.

The elastomeric protein can be obtained from in vitro culture such as cell culture, microbial culture, or yeast culture as well as from animal or plant sources.

As it is illustrated in examples, the elastomeric protein matrix can comprise at least 1% in weight of elastomeric protein with respect to the total wet weight of the elastomeric protein matrix, preferably at least 3% of elastomeric protein in weight with respect to the total weight of the elastomeric protein matrix. More preferably, the elastomeric protein matrix further comprises at least 4% of elastomeric protein in weight with respect to the total weight of the elastomeric protein matrix (e.g. wet weight). Even more preferably, the elastomeric protein matrix further comprises at least 5% of elastomeric protein in weight with respect to the total weight of the elastomeric protein matrix (e.g. wet weight). Preferably, said elastomeric protein being from non-human cultivated animal cells or extracts of said cells.

However, the elastomeric protein matrix preferably should not comprise a high quantity of elastomeric proteins and in particular non-human animal elastomeric proteins. Hence, the elastomeric protein matrix can comprise at most 40% of elastomeric protein in weight with respect to the total weight of the elastomeric protein matrix. Preferably, the elastomeric protein matrix comprises at most 35% of elastomeric protein in weight with respect to the total weight of the elastomeric protein matrix. More preferably, the elastomeric protein matrix further comprises at most 32.5% of elastomeric protein in weight with respect to the total weight of the elastomeric protein matrix. Even more preferably, the elastomeric protein matrix further comprises at most 30% of elastomeric protein in weight with respect to the total weight of the elastomeric protein matrix (e.g. wet weight).

For example, the elastomeric protein matrix comprises from 1% to 40% in weight of elastomeric protein with respect to the total weight of the elastomeric protein matrix. Preferably, the elastomeric protein matrix further comprises from 3% to 35% in weight of elastomeric protein with respect to the total weight of elastomeric protein matrix. More preferably, the elastomeric protein matrix further comprises from 4% to 32.5% in weight of elastomeric protein with respect to the total weight of elastomeric protein matrix. Even more preferably, the elastomeric protein matrix further comprises from 5% to 30% in weight of elastomeric protein with respect to the total weight of the elastomeric protein matrix (e.g. wet weight).

As it is illustrated in the example, the elastomeric protein matrix can further comprise at least one polysaccharide.

In particular, a polysaccharide preferred for the elastomeric protein matrix can be selected from: agar, alginates, carrageenans such as kappa carrageenan or iota carrageenan, pectin, pullulan, gellan high acyl or gellan low acyl, dextran, starch, xanthan gum, guar gum, arabic gum, konjac gum and combination thereof.

A preferred polysaccharide for the elastomeric protein matrix is an anionic polysaccharide such as carboxylate polysaccharides. Hence, preferred polysaccharide for the elastomeric protein matrix is selected from pectin, alginates or combination thereof.

A polysaccharide preferred for the elastomeric protein matrix can be obtained from: extraction of natural sources, in vitro culture such as microbial fermentation, chemical synthesis; and/or enzymatic synthesis.

The ratio of elastomeric protein to polysaccharide in the elastomeric protein matrix may be in the range of 100:1 to 1:100, preferably in the range of 50:1 to 1:50, more preferably in the range of 10:1 to 1:10; even more preferably in the range of 5:1 to 1:5. The specific ratio of elastomeric protein to polysaccharide in the composition may be adjusted based on the desired properties of the edible food product, such as texture, mouthfeel, and stability.

The elastomeric protein matrix preparation can be prepared through several steps such as ingredient characterization (e.g. moisture content, Young modulus, protein quantification), mixing, solubilization, purification, and extraction.

The elastomeric protein matrix may be used in varying proportions, depending on the desired properties of the edible food product. While the specific proportion may vary depending on the type of matrix and the application, the elastomeric protein matrix can be present at at least 1% by weight relative to the total weight of the edible food product. The elastomeric protein matrix is preferably present at at least 2% by weight relative to the total weight of the edible food product, more preferably at least 4% by weight, even more preferably at least 6% by weight.

However, it is also recommended that the proportion of the elastomeric protein matrix in the edible food product should not exceed 30% by weight to avoid any negative impacts on taste or texture. The elastomeric protein matrix is preferably present at at most 25% by weight relative to the total weight of the edible food product, more preferably at most 20% by weight, even more preferably at most 15% by weight.

Thus, the elastomeric protein matrix may be used at a range of 1% to 30% by weight relative to the total weight of the edible food product. The elastomeric protein matrix is preferably present at a range of 2% to 25% by weight relative to the total weight of the edible food product, more preferably at a range of 4% to 20% by weight, even more preferably at a range of 6% to 15% by weight.

These proportions are believed to provide optimal texture, juiciness and appearance.

The elastomeric protein matrix can comprise a network, formed with the elastomeric proteins and/or the polysaccharides. Said network has, for example, a Young's modulus of at least 1 kPa. Preferably, the network optionally found in the elastomeric protein matrix has a Young's modulus of at least 5 kPa, more preferably of at least 10 kPa, and even more preferably of at least 20 kPa. For example, said network has a Young's modulus of at most 20 MPa. Preferably, the network optionally found in the elastomeric protein matrix has a Young's modulus of at most 10 MPa, more preferably of at most 5 MPa, and even more preferably of at most 2 MPa.

The Young's moduli of these networks formed by the elastomeric proteins and/or the polysaccharides can be obtained through direct measurement of force under stretching, mostly using atomic force spectroscopy (AFM).

The protein matrix, the fatty matrix and the elastomeric protein matrix can undergo various preparations to improve the efficiency of protein threads formation and the edible food product formation. The drawings and the present description should not be understood as limiting the invention to an embodiment wherein the protein matrix is prepared before the fatty matrix or the elastomeric protein matrix. The person skilled in the art knows that, within the scope of the invention, the fatty matrix or the elastomeric protein matrix can also be prepared before the protein matrix or concomitantly.

The protein matrix, the fatty matrix and/or the elastomeric protein matrix can undergo physical treatment such as blending, mixing, homogenizing, sieving, or sonication. Preferably, the steps of preparation of the protein matrix, the elastomeric protein matrix or the fatty matrix can comprise a blending or homogenizing or emulsifying or stirring steps. These steps are in particular designed to homogenize or to mix all the components together. Also, these steps can result in a, at least partial, disruption of the cultivated non-human animal cells, when present. The steps of preparation of the protein matrix can comprise a disruption of the membrane of the non-human animal cells. Hence, the homogenizing step can be a blending step. It can for example be used when the matrix has been supplemented with other ingredients such as plant material or food additives. Preferably, the homogenizing or blending or emulsifying, or stirring step is performed with a high-speed mixer, or with a homogenizer, as a rotor-stator homogenizer, a cutter or a colloid mill.

The homogenizing may be conducted during at least 30 seconds, preferably at least 1 min, more preferably at least 2 min; for example, at least 10 min. The homogenizing step may be conducted during at most 60 min, preferably at most 45 min, more preferably at most 30 min; even more preferably at most 10 min; for example, at most 2 min. Hence, the homogenizing may be conducted during 30 sec to 60 min, preferably during 1 min to 45 min, more preferably during 2 min to 30 min; for example during about 10 minutes.

The homogenizing may be conducted at least at 100 rpm, preferably at least 1000 rpm, more preferably at least 2000 rpm; for example, at least 5000 rpm. The homogenizing may be conducted during at most at 30 000 rpm, preferably at most 25 000 rpm, more preferably at most 20 000 rpm; for example, at most at 15 000 rpm. Hence, the homogenizing may be conducted at 100 rpm to 30 000 rpm, preferably at 1000 rpm to 25 000 rpm, more preferably at 2 000 rpm to 20 000 rpm; even more preferably at 5 000 rpm to 15 000 rpm. The homogenization preferably induces an emulsion. In particular, the method 100 of the invention can comprise an homogenization of the fatty matrix to create an oil in water emulsion in the fatty matrix or an water in oil emulsion in the fatty matrix. Preferably the homogenization is conducted at least at 100 rpm for a period of at least 30 seconds.

Furthermore, a method according to the invention can comprise a step of adding a food additive in one or several of the prepared matrix. The food additive can be added to the protein matrix, the fatty matrix, and/or the elastomeric protein matrix. This step is in particular designed to improve the flavor, the texture, the appearance or the shelf-life of the edible food product. One or several of matrices may comprise between 0.01 and 25% in weight of food additive, preferably between 0.01 and 10% in weight of food additive compared to the total wet weight of the according matrix. In turn, the protein threads may comprise between 0.01 and 10% in weight of food additive compared to the total weight of the protein threads, preferably between 0.01 and 4% in weight of food additive compared to the total weight of the protein threads.

The food additive can be selected from seasoning, flavoring additive, texturizing additive, food colorant, preservative additive or a combination thereof.

A food additive can be for example seasoning, mineral salt, flavoring additive, humectant additive, texturizing additive, anti-foaming agent, emulsifying additive, firming agent, gelling agent, stabilizing additive, thickening agent, food colorant, preservative additive or a combination thereof.

A seasoning can for example be selected from: salt; pepper; aromatic herbs and/or spices, including rosemary, sage, mint, oregano, parsley, thyme, bay leaf, cloves, basil, chives, marjoram, nutmeg, cardamom, chiles, cinnamon, fennel, fenugreek, ginger, saffron, vanilla and coriander; alcohol, including wine such as jurançon, sauterne or pacherenc, spirituous such as cognac or armagnac; or any combination thereof.

A flavoring additive can for example be selected from: flavor enhancer, sweetener, or any combination thereof.

A texturizing additive can for example be selected from: bulking agent or thickener, desiccant, curing agent or any combination thereof. For example, the protein matrix can further comprise a texturizing additive such as carrageenan, pectin, pullulan, dextran, starch.

Preferably, and as illustrated in examples, the fatty matrix can further comprise a hydrocolloid such as methylcellulose or gums.

A preservative additive can for example be selected from: antimicrobial agent, pH modulator, or any combination thereof.

A food colorant can for example be selected from colorants extracted from natural sources such as carotenes, anthocyanins, tomato (lycopene), beetroot (betacyanins and betaxanthins), or a mixture of thereof. The edible food product may comprise between 0.01% and 4% of food colorants compared to the total weight of the edible food product.

As shown in FIG. 1, a method according to the invention can comprise a step of processing 140 the protein matrix to form one or more protein thread(s).

This step 140 is in particular designed to form an edible protein thread which will be associated with a fatty matrix. More particularly, several edible protein threads that can be prepared concomitantly.

For example, this step 140 can comprise the use of a dry spinning or an electrospinning to form one or more protein thread(s). In particular, it can comprise the use of a texturizing molecule in the protein matrix combined with dry spinning or electrospinning.

For example, this step 140 can comprise contacting the protein matrix with a coagulation composition, in particular a coagulation bath. This step 140 is preferably achieved using a threading device 10.

More preferably, this step of processing 140 the protein matrix to form one or more edible protein thread(s) 220 comprises contacting the protein matrix with a coagulation composition to form an edible protein thread.

Contacting the protein matrix with the coagulation composition can be performed by known methods such as extrusion spinning, gel spinning, melt spinning, centrifugal spinning, bath-assisted 3D printing, wet spinning or a dry jet wet spinning. Preferably, the contacting is performed by wet spinning or a dry jet wet spinning, bath-assisted 3D printing. More preferably, the contacting is performed by wet spinning or a dry jet wet spinning.

In particular, the contacting of the protein matrix with the coagulation composition can comprise impregnating a thread made of the protein matrix with the coagulation composition and preferably immersing the protein matrix in a bath made of the coagulation composition to form a thread. Preferably, a flow could be created in the coagulation composition and/or the threads could be spooled (can be advantageously done so they are straightened up). In particular, the contacting comprises an immersion of the protein matrix in the coagulation composition and the formation of the edible protein thread in a bath made of the coagulation composition.

The contacting can be performed during at least 10 ms, preferably during at least 100 ms, more preferably during at least 500 ms, even more preferably during at least 1 second. The contacting can be performed during at most 20 minutes, preferably during at most 10 minutes, more preferably during at most 5 minutes, even more preferably during at most 4 minutes. Hence, the contacting can be performed during from 10 ms to 20 min preferably during from 100 ms to 10 minutes more preferably during from 500 ms to 5 minutes, even more preferably during from 1 second to 4 minutes.

The protein threads can exhibit a great diversity of shape and size. For example, protein threads can exhibit diverse cross-sectional shapes, including but not limited to round, oval, ribbon-like, trilobal, and multi-lobal shape.

For example, the protein threads can have a cross section area of at most 1,000,000 μm², preferably at most 100,000 μm², more preferably at most 5,000 μm², even more preferably at most 2,000 μm².

When they have substantially round cross-sectional shapes, the protein threads can have diameters ranging from a few micrometers up to several hundred micrometers.

The protein threads can be arranged in multi-thread/bundle fibers or in mono-thread fibers.

### Form a Heat Resistant Complex

The step 140 of processing the protein thread(s) preferably comprises the formation of a heat-resistant complex. The formation of a heat-resistant complex preferably comprises the use of a texturizing molecule which improves the properties of the edible protein threads.

For example, a texturizing molecule can be a cross-linking molecule. Preferably it can be selected among the cross-linking molecules already described in this description.

The formation of a heat-resistant complex can comprise the use of a heat-resistant gel-forming polyelectrolyte which improves the properties of the edible protein threads. The method 100 according to the invention preferably uses a polyvalent ion and polyelectrolyte which are complementary and which, when combined, produce a heat-resistant gel.

The protein matrix or the coagulation composition comprises a polyelectrolyte which is capable of complexing with the polyvalent ion to form a heat-resistant complex.

Hence, the protein matrix also comprises either a polyvalent ion or a polyelectrolyte. The polyelectrolyte and the polyvalent ion are capable of complexing together to form a heat-resistant complex.

Typically, when the protein matrix comprises one of either the polyvalent ion or the polyelectrolyte, the coagulation composition comprises the other. The polyvalent ion and the polyelectrolyte can then be combined at the step of processing 140 the protein matrix to form one or more protein thread(s).

Preferably, the protein matrix comprises a polyelectrolyte which is capable of complexing with a polyvalent ion to form a heat-resistant complex. In this embodiment, the polyvalent ion capable of complexing with the polyelectrolyte is in the coagulation composition. For example, the protein matrix comprises the polyelectrolyte at a concentration of at least 0.01% compared to the total wet weight of the protein matrix. Preferably, the protein matrix comprises at least 0.1% in weight of the polyelectrolyte capable of complexing with the polyvalent ion with respect to the total wet weight of the protein matrix, more preferably at least 0.5%, and even more preferably at least 1% in weight with respect to the total wet weight of the protein matrix.

Alternatively, the protein matrix comprises a polyvalent ion which is capable of complexing with a polyelectrolyte to form a heat-resistant complex. In this embodiment, the polyelectrolyte, capable of complexing with the polyvalent ion, is in the coagulation composition.

### Polyelectrolyte

As mentioned, the polyelectrolyte appropriate to form the heat-resistant gel can be added to the protein matrix or the coagulation composition. A minimal quantity of polyelectrolyte can be of interest to improve the properties of the thread.

Hence, the protein matrix or the coagulation composition can comprise at least 0.01% in weight of polyelectrolyte compared to the total wet weight of the related composition. Preferably, the protein matrix or the coagulation composition can comprise at least 0.02% in weight of polyelectrolyte compared to the total wet weight of the related composition; more preferably at least 0.05% in weight, even more preferably at least 0.1% in weight, compared to the total wet weight of the related composition.

In particular, when the protein matrix comprises the polyelectrolyte, said protein matrix can comprise at least 0.1% in weight of polyelectrolyte compared to the total wet weight of the protein matrix. Preferably, the protein matrix can comprise at least 0.2% in weight of polyelectrolyte compared to the total wet weight of protein matrix; more preferably at least 0.3% in weight compared to the total wet weight of the protein matrix. When the concentration of a polyelectrolyte is mentioned herein, it preferably refers to the concentration of the polyelectrolyte salt.

The protein matrix or the coagulation composition can comprise at most 15% in weight of polyelectrolyte compared to the total wet weight of the related composition. Preferably, the protein matrix or the coagulation composition can comprise at most 10% in weight of polyelectrolyte compared to the total wet weight of the related composition; more preferably at most 5% in weight, even more preferably at most 3% in weight, compared to the total wet weight of the related composition.

The protein matrix or the coagulation composition can comprise from 0.01% to 15% in weight of polyelectrolyte compared to the total wet weight of the related composition. Preferably, the protein matrix or the coagulation composition can comprise from 0.02% to 10% in weight of polyelectrolyte compared to the total wet weight of the related composition; more preferably from 0.05% to 5% in weight, even more preferably from 0.1% to 3% in weight, compared to the total wet weight of the related composition.

As mentioned, the polyelectrolyte is a heat-resistant gel-forming polyelectrolyte. Preferably, also, the polyelectrolyte is not a heat-activable gel-forming polyelectrolyte. For example, the polyelectrolyte does not need a heat treatment at a temperature above 80° C., preferably above 60° C., to be activated.

Also, since it is intended for human consumption, the polyelectrolyte is digestible by the human digestive system.

For example, the polyelectrolyte is either cationic (e.g. chitosan) or anionic (e.g. alginate). Preferably, when the polyelectrolyte is an anionic polyelectrolyte then the polyvalent ion is a polyvalent cation. Also, when the polyelectrolyte is a cationic polyelectrolyte then the polyvalent ion is a polyvalent anion. More preferably, the polyelectrolyte is an anionic polysaccharide.

It is not necessary that all the monomers of the polyelectrolyte carry an ionisable group. For example, the polyelectrolyte is a polymer having at least 10% of its monomers bearing an ionisable group, preferably at least 20%, more preferably at least 30% and even more preferably at least 40%. Preferably, the ionisable group is selected from amine, carboxylic, sulphate, or phosphate groups.

For example, the polyelectrolyte is a polymer having at least 10% of its monomers that can be negatively charged, preferably at least 20%, more preferably at least 30%, for example all the monomers can be negatively charged. Preferably, a monomer that can be negatively charged comprises at least one anionic group. Preferably, the anionic group is selected from carboxylic, sulphate, or phosphate groups, more preferably the anionic group is a carboxylic group.

For example, the polyelectrolyte is a polymer having at least 10% of its monomers that can be positively charged, preferably at least 20%, more preferably at least 30%, even more preferably at least 40%, for example all the monomers can be positively charged. Preferably, a monomer that can be positively charged comprises at least one cationic group. Preferably, the cationic group is an amine.

Preferably, the polyelectrolyte is a high molecular weight polyelectrolyte. For example, the polyelectrolyte has an average molar mass of at least 2 kg·mol⁻¹. Preferably, the polyelectrolyte has an average molar mass of at least 10 kg·mol⁻¹; more preferably, the polyelectrolyte has an average molar mass of at least 20 kg·mol⁻¹; even more preferably the polyelectrolyte has an average molar mass of at least 30 kg·mol⁻¹.

For optimized texture, the polyelectrolyte molecular weight should not be too high. For example, the polyelectrolyte has an average molar mass of at most 3000 kg·mol⁻¹. Preferably, the polyelectrolyte has an average molar mass of at most 2500 kg·mol⁻¹; more preferably, the polyelectrolyte has an average molar mass of at most 2000 kg·mol⁻¹; even more preferably the polyelectrolyte has an average molar mass of at most 1500 kg·mol⁻¹.

Hence, for example, the polyelectrolyte has an average molecular mass from 2 kg·mol⁻¹ to 3000 kg·mol⁻¹. Preferably, the polyelectrolyte has an average molar mass from 10 kg·mol⁻¹ to 2500 kg·mol⁻¹; more preferably, the polyelectrolyte has an average molar mass from 20 kg·mol⁻¹ to 2000 kg·mol⁻¹; even more preferably the polyelectrolyte has an average molar mass from 30 kg·mol⁻¹ to 1500 kg·mol⁻¹.

The average molecular weight of the polyelectrolyte can be measured by size exclusion chromatography coupled with light scattering. Preferably, it can be measured by following the instructions of the international norm ISO 16014-5:2019.

The present invention can use several polyelectrolytes. However, some polyelectrolytes are preferred. Preferably, the polyelectrolytes are selected from: low methoxyl pectin, low methoxyl pectin derivatives, high methoxyl pectin, high methoxyl pectin derivatives, alginate, alginate derivatives, xanthan, xanthan derivatives, chitosan, chitosan derivatives, ionic carboxymethyl-cellulose derivatives, ionic pullulan derivatives, ionic dextran derivatives, ionic starch derivatives, or a combination thereof or a combination thereof.

More preferably the polyelectrolyte is selected from alginate, alginate derivatives, low methoxyl pectin, low methoxyl pectin derivatives, chitosan, chitosan derivatives or combination thereof.

Even more preferably the polyelectrolyte is selected from alginate, low methoxyl pectin, chitosan, or combination thereof.

### Polyvalent Ion

As mentioned, in a method according to the invention, the polyvalent ion combines with the polyelectrolyte to form a heat-resistant gel.

The polyvalent ion can be either polyvalent anion or a polyvalent cation. For example, the polyvalent ion is selected among: calcium, magnesium, iron, manganese, copper, zinc, carbonate, oxalate, sulfate, sulfite, phosphate or combination thereof. Preferably, the polyvalent ion is selected among: calcium, magnesium, iron, manganese, copper, zinc, carbonate, oxalate, sulfate, phosphate or combination thereof.

The polyvalent ion can be obtained by dissolving the form of a salt. For example, the counter ions can be selected among: calcium, magnesium, sodium, ammonium, chloride, gluconate, lactate, sulfate, carbonate, phosphate, or combination thereof. When the concentration of a polyvalent ion is mentioned herein, it preferably refers to the concentration of the polyvalent ion as such.

The polyvalent ion is present in either the protein matrix or the coagulation composition. It can be present at a concentration of at least 0.001% in weight compared to the wet weight of the composition, preferably at least 0.002%, more preferably at least 0.005% and even more preferably at least 0.01%, compared to the wet weight of the composition.

The maximum concentration of the polyvalent ion is usually directed by the solubility of the polyvalent ion. For example, the polyvalent ion can be present in either the protein matrix or the coagulation composition at a concentration of at most 3% in weight compared to the wet weight of the composition, preferably at most 2%, more preferably at most 1% and even more preferably at most 0.5%, compared to the wet weight of the composition.

Hence, the polyvalent ion can be present in either the protein matrix or the coagulation composition at a concentration from 0.001 to 3% in weight compared to the wet weight of the composition. Preferably, the polyvalent ion is present in either the protein matrix or the coagulation composition at a concentration from 0.002 to 2% in weight compared to the wet weight of the composition; more preferably from 0.005 to 1% in weight, even more preferably from 0.01 to 0.5% in weight, compared to the wet weight of the composition.

As shown in FIG. 1, a method according to the invention can comprise a step of guiding 150 the one or more edible protein thread(s).

This step 150 can be designed to manipulate the edible protein thread(s) according to a predetermined pattern. As the pattern can influence the appearance of the food product, such a step can contribute to the resolution of the problems solved by the invention.

This step 150 may involve the use of a guiding device 50. Also, this step may involve the use of a collecting device 30.

Preferably, during the step of guiding 150 the one or more edible protein thread(s), the guiding device 50 and the collecting device 30 cooperate to obtain an assembly of edible protein thread(s) 280. Advantageously, the obtained assembly can have a predetermined pattern of edible protein thread(s). For example, the obtained assembly can have the shape of a piece of meat.

The guiding 150 step can comprise the use of a guiding device 50 which preferably comprises a traverse mechanism as it is described hereafter in relation with a system of the invention.

The step of guiding 150 the one or more edible protein thread(s) can ensure the proper distribution of the edible protein thread(s) throughout the production process. This step 150 can also comprise adjusting edible protein thread(s) tension, and/or temperature. However, this step 150 is mainly designed to participate in the production of an edible food product with a predetermined pattern of edible protein thread(s).

As it is described hereafter, the guiding 150 step is preferably synchronized with other processes such as the steps of adding 160 the fatty matrix and/or adding 170 the elastomeric protein matrix. Proper synchronization ensures that the fiber is guided through each stage of the production process at a consistent speed and tension, which helps maintain controlled distribution and alignment of the protein threads.

A method 100 according to the invention can further comprise a step of drying the edible protein thread. Preferably, the drying step is conducted when the edible protein thread is on the collecting device.

As shown in FIG. 1, a method 100 according to the invention can comprise a step of adding 160 the fatty matrix on the one or more edible protein thread(s).

This step 160 is in particular designed to precisely combine the fatty matrix with the edible protein thread(s) and thus creating an expected meat substitute, preferably a marbled meat substitute. As the addition of the fatty matrix can influence the appearance of the edible food product, such a step 160 can contribute to the resolution of the problems solved by the invention.

The fatty matrix is preferably added on the protein threads while they are being collected by the collecting device. The addition is preferably done so that the fatty matrix is positioned within the assembly of edible protein thread(s). In particular, the fatty matrix is positioned in controlled positions following a deposition pattern (e.g. preferably predetermined pattern) of fat within the assembly of edible protein thread(s) so as to generate for example a marbling pattern. For example, the fatty matrix addition is done during the guiding and in particular on portions of protein threads in contact with the collecting device or in contact with portions of protein thread already collected.

Preferably, the fatty matrix is added on a portion of the one or more edible protein threads from the moment said portion of the edible protein thread has been in contact with the collecting device 30 or in contact with a portion of the edible protein thread already collected on the collecting device 30.

Advantageously, the collecting device 30 is moving while cooperating with the guiding device 50. In particular, it is also moving when adding the fatty matrix. Movements can be achieved using a linear actuator, pneumatic or hydraulic cylinder, or a mechanical linkage system. During the process, the collecting device 30 can operate in a rotational movement. The collecting device 30 can have a transverse movement for example where it moves horizontally (i.e. transversely) across the width of another roller or device; a vertical movement for example where it moves vertically to accommodate changes in the protein thread's path, tension, or to engage and disengage with the protein thread during processing; a pivoting movement for example where it pivots around an axis to change the angle at which it engages the protein thread; and/or eccentric movement for example where it is mounted on an eccentric or offset axis, causing it to oscillate and create a controlled level of randomness in the protein thread distribution on the collecting device 30.

The fatty matrix can be added with one or several dispensing device(s) 60. In particular, the fatty matrix is added with one or several dispensing device(s) 60 comprising one or several dispensing hole(s) as it is described hereafter in relation with the system 1 of the invention.

Preferably, during the fatty matrix adding 160 step, the dispensing device 60 and the collecting device 30 cooperate so as to position the fatty matrix within the assembly of edible protein threads.

The fatty matrix adding 160 step can ensure the proper distribution of the fatty matrix throughout the production process. This step 160 can also comprise adjusting fatty matrix flow rate, and/or temperature. However, this step 160 is mainly designed to participate in the production of an edible food product with a predetermined pattern of fat.

As it is described hereafter, the fatty matrix adding 160 step is preferably synchronized with other process steps such as the steps of guiding 150 the protein threads, adding 170 the elastomeric protein matrix. Proper synchronization ensures that the fatty matrix is added in a controlled manner so as to produce a predetermined pattern.

As shown in FIG. 1, a method according to the invention can comprise a step of adding 170 an elastomeric protein matrix to the assembly. Preferably, the addition is done during the formation of the assembly.

Hence, the elastomeric protein matrix can be positioned within the assembly of edible protein thread(s). This can participate to create a realistic visual effect of small fibers when pulling the piece of meat in a direction perpendicular to the fiber alignment (like in conventional meat). Also, this step can be designed to enhance the juiciness of the edible food product produced.

The elastomeric protein matrix can be added on the one or more edible protein threads. Preferably, the elastomeric protein matrix is added on a portion of the one or more edible protein threads from the moment said portion of the edible protein thread has been in contact with the collecting device 30 or in contact with a portion of the edible protein thread already collected on the collecting device 30.

The elastomeric protein matrix can be added:
in the form of preformed network, for example in the form of a film like structure;
in the form of a preformed protein-polysaccharide composite network, for example in the form of a film like structure;
through a coaxial spinning process, the elastomeric protein matrix being used on the outer needle;
in the form of a solution, from the moment the edible protein thread is guided 150 by the guiding device 50 to the collecting device 30; or
in the form of a solution, from the moment the edible protein thread is in contact with the collecting device 30.

In particular, the step of adding 170 an elastomeric protein matrix on the one or more edible protein threads is conducted so that the elastomeric protein matrix is positioned between two layers of edible protein threads, preferably it is positioned within the assembly. In particular, the elastomeric protein matrix is positioned in a controlled position so as to generate a deposition pattern (preferably predetermined pattern) of elastomeric protein matrix within the assembly of edible protein thread(s). For example, the elastomeric protein matrix addition is done during the guiding and in particular on the portion of protein threads in contact with the collecting device or in contact with the portion of protein thread already collected.

Preferably, the step of adding 170 the elastomeric protein matrix can also comprise an addition of a composition on the elastomeric protein matrix to help it solidify. This can be done by adding a composition that can accelerate the formation of a network or that can strengthen the network. Also, the step of adding 170 the elastomeric protein matrix can comprise an acceleration of the evaporation of a solvent that dissolves the elastomeric protein (e.g. with a fan) in order to solidify and/or form the network.

The elastomeric protein matrix can be added with one or several dispensing device(s) 70. In particular, the elastomeric protein matrix is added with one or several dispensing 70 device(s) comprising one or several dispensing hole(s) as it is described hereafter in relation with the system of the invention. Alternatively, the dispensing 70 device can comprise rollers configured to bring into contact the elastomeric protein matrix with the protein threads. This is particularly suitable when the elastomeric protein matrix is in the form of a film.

Preferably, during the elastomeric protein matrix adding 170 step, the dispensing device 70 and the collecting device 30 cooperate so as to position the elastomeric protein matrix within the assembly of edible protein thread. This can ensure the proper distribution of the elastomeric protein matrix throughout the production process.

As it is described hereafter, the addition of the elastomeric protein matrix is preferably synchronized with other processes such as the steps of guiding 150 the protein threads, and/or the step of adding 160 the fatty matrix.

In a preferred embodiment of the method 100 of the invention, it comprises the use of:
a protein matrix comprising at least 5% in weight of total proteins, preferably at least 10% in weight of total proteins, with respect to the total wet weight of the protein matrix, said total proteins including at least 5% of non-human animal proteins with respect to the total proteins weight; and
a fatty matrix comprising at least 50% in weight of triglycerides, preferably at least 90% in weight of triglycerides, with respect to the total weight of fat in the fatty matrix and comprising a solid fat content ranging from 0.1 to 45%, preferably from 0.1 to 8% with respect to the total weight of fat in the fatty matrix, at 20° C. as measured according to the norm ISO 8292-2:2008.

In a preferred embodiment of the method 100 of the invention, it comprises the use of:
a protein matrix comprising at least 5% in weight of total proteins, preferably at least 10% in weight of total proteins, with respect to the total wet weight of the protein matrix, said total proteins including at least 5% of non-human animal proteins with respect to the total proteins weight;
a fatty matrix comprising at least 20% in weight of fat, preferably at least 40% in weight in plant fat and/or fermented fat, with respect to the total wet weight of the fatty matrix, and at least one polysaccharide.

In a preferred embodiment of the method 100 of the invention, it comprises the use of:
a protein matrix comprising at least 5% in weight of total proteins, preferably at least 10% in weight of total proteins, with respect to the total wet weight of the protein matrix, said total proteins including at least 5% of non-human animal proteins with respect to the total proteins weight;
a fatty matrix comprising at least 20% in weight of fat, preferably at least 40% in weight in plant fat and/or fermented fat, with respect to the total wet weight of the fatty matrix; and
an elastomeric protein matrix comprising at least 1% in weight of elastomeric proteins with respect to the total wet weight of the elastomeric protein matrix, and at least one polysaccharide.

In a preferred embodiment of the method 100 of the invention, it comprises the use of:
a protein matrix comprising at least 5% in weight of total proteins, preferably at least 10% in weight of total proteins, with respect to the total wet weight of the protein matrix, said total proteins including at least 0.25% in weight of myofibrillar proteins with respect to the total weight of proteins; and
a fatty matrix comprising at least 20% in weight of fat, preferably at least 40% in weight in plant fat and/or fermented fat, with respect to the total wet weight of the fatty matrix.

In a preferred embodiment of the method 100 of the invention, it comprises the use of:
a protein matrix comprising at least 5% in weight of total proteins, preferably at least 10% in weight of total proteins, with respect to the total weight of the protein matrix, said total proteins including at least 2% of myofibrillar proteins with respect to the total weight of proteins;
a fatty matrix comprising at least 20% in weight of fat, preferably at least 40% in weight in plant fat and/or fermented fat, with respect to the total wet weight of the fatty matrix; and
an elastomeric protein matrix comprising at least 1% in weight of elastomeric proteins and at least one polysaccharide.

In a preferred embodiment of the method 100 of the invention, it comprises the use of:
a protein matrix comprising at least 5% in weight of total proteins, preferably at least 10% in weight of total proteins, with respect to the total wet weight of the protein matrix, said total proteins comprising plant proteins, said total proteins including at least 0.25% in weight of myofibrillar proteins with respect to the total weight of proteins, and said protein matrix comprising at least 1% in dry weight of cultivated non-human animal cells compared to the total wet weight of the protein matrix; and
a fatty matrix comprising at least 20% in weight of fat, preferably at least 40% in weight in plant fat and/or fermented fat, with respect to the total wet weight of the fatty matrix.

In a preferred embodiment of the method 100 of the invention, it comprises the use of:
a protein matrix comprising at least 5% in weight of total proteins, preferably at least 10% in weight of total proteins, with respect to the total wet weight of the protein matrix, said total proteins including at least 0.25% in weight of myofibrillar proteins with respect to the total weight of proteins;
a fatty matrix comprising at least 50% in weight of triglycerides with respect to a total weight of fat in the fatty matrix, said triglycerides of the fatty matrix comprising more than 40% in weight of unsaturated C18 fatty acids with less than four carbon-carbon double bonds with respect to the total weight of triglycerides in the fatty matrix.

In a preferred embodiment of the method 100 of the invention, it comprises the use of:
a protein matrix comprising at least 5% in weight of total proteins, preferably at least 10% in weight of total proteins, with respect to the total wet weight of the protein matrix, said total proteins including at least 1% in weight of collagen compared to the total weight of proteins in the protein matrix;
a fatty matrix comprising at least 20% in weight of fat, preferably at least 40% in weight in plant fat and/or fermented fat, with respect to the total wet weight of the fatty matrix, and said fatty matrix comprising at least 0.25% in weight of non-human animal proteins with respect to the total wet weight of the fatty matrix.

In a preferred embodiment, the guiding 150 step, the fatty matrix adding 160 step and/or the elastomeric protein matrix adding 170 step are done automatically according to a deposition pattern.

For example, except for the very first protein thread(s) that will be first guided then collected, the method can comprise a continuous process in which guiding, collecting and deposition of fat and eventually elastomeric matrix happen at the same time and in a controlled way. This can be implemented using programs that monitor and adjust the speed of each step in real time.

The deposition pattern can be a predefined pattern but also a fuzzy pattern allowing some degree of randomness.

The deposition pattern on the collecting device can be different from the marbling pattern awaited. However, once finished, the edible food product removed from the support will have the awaited marbling effect thanks to the deposition pattern applied. Indeed, in a preferred embodiment, the deposition pattern can correspond to a transformation of the marbling pattern into instructions forming the deposition pattern. Once the deposition pattern has been executed and the edible product collected and eventually further processed as described later, the edible food product will exhibit the awaited marbling pattern.

The guiding 150 step, the fatty matrix adding 160 step and/or the elastomeric protein matrix adding 170 step can comprise movements of the guiding device 50 and/or the dispensing device(s) 60, 70 according to a marbling effect to be produced in the edible food product. These movements can be made according to a predetermined pattern or can be determined during the process of producing the edible food product. In particular, the guiding device 50 and the collecting device 30 are automatically operated to ensure that the edible protein thread(s) are deposited on the collecting device 30 according to a deposition pattern, said deposition pattern being defined so as to generate an expected marbling pattern in the edible food product.

Hence, a method 100 according to the invention can further comprise a step of designing a model of the edible food product to be produced. Preferably, the model designed is a 2D model of a slice of the edible food product to be produced. Alternatively, the model designed can be a 3D model of an edible food product to be produced. This step can comprise the use of modeling software such as computer-aided design software configured to automatically generate design from provided parameters. It can also be obtained from scanning a meat to replicate, or downloading a model from an online database.

The method 100 also comprises a step of providing or loading in memory a model of the edible food product to be produced.

The method can comprise a step of preparing the model for example by checking for errors, repairing any detected errors, and scaling the model to the desired size.

When a model representing the expected shape is available, the method 100 of the invention can comprise a step of generating a system-readable code, using for example a slicing software program that generates the instructions for the manufacturing system 1 to follow. The instructions generated preferably include parameters such as temperature, protein matrix flow rate, pressure, tension applied on the threads, guiding device 50 displacement and collecting device 30 displacement.

The instruction, for example in the form of a system-readable code can then be loaded onto the manufacturing system using any communication means.

As shown in FIG. 1, a method 100 according to the invention can comprise a step of monitoring 180 the assembly during its formation. This monitoring step 180 can have several applications such as: generating assembly data, generating quality control data, feeding an automatic error correction system and/or feeding a closed loop control system.

This step 180 can be conducted thanks to a monitoring device 80 which will be described hereafter.

A variety of sensors can be used to monitor the assembly during its formation such as temperature sensors, humidity sensors and provide real-time feedback on the assembling conditions. The monitoring preferably comprises an acquisition of a video stream comprising the assembly during its formation. Preferably, one or more cameras are used to monitor the assembling process, allowing for real-time observation of the edible food product being produced. The cameras, providing a live video feed of the assembling job, can be connected to a computer or other device that uses software to analyze the video feed and detect any errors or anomalies. The software can also provide visualizations of the assembling process. The video stream can comprise visible images, ultraviolet images and/or infrared images. However, more preferably, the camera is a visible camera (i.e. RGB camera), for example using wavelengths of light from 400˜700 nm. The camera can be a camera configured to generate depth data.

This step of monitoring 180 can generate assembly data which comprises information on the conditions of the formation of the assembly (e.g. temperature, humidity, . . . ) and parameters of the assembly in formation (e.g. video). The method 100 can thus comprise a step of controlling the guiding device 50, the dispensing device(s) 60, 70 and/or the collecting device 30 based on the assembly data. Preferably, it comprises a modification of predetermined instructions based on the assembly data generated.

The monitoring can be used to generate quality control data. The generated quality control data can be used to ensure the quality of the produced edible food product meets desired specifications. For example, the monitoring means are connected to a computer or other device that uses software to analyze the food edible product being produced and verify that it meets the desired specifications.

The monitoring can also be combined with an automatic error correction. In particular, the data generated during the monitoring step 180 can be used to automatically detect and correct errors in the assembling process.

The monitoring can advantageously be combined with a closed-loop control. In particular, the method 100 comprises a step of adjusting the assembling process in real-time based on the data produced during the step of monitoring. Preferably, the method 100 comprises an adjustment of the processing parameters, such as temperature, protein matrix flow rate, pressure, tension applied on the threads, guiding device 50 displacement and collecting device 30 displacement. In a more preferred embodiment, the closed-loop control comprises the use of machine learning algorithms to learn from past assembling jobs and optimize the assembling parameters for future jobs. The closed-loop control step can also use predictive analytics to anticipate and prevent errors before they occur.

The method 100 can further comprise a step of collecting the assembly of edible protein threads. The assembly of edible protein threads can be considered as the edible food product.

The method 100 can further comprise a step of compacting the assembly of edible protein threads.

Once harvested, the assembly of edible protein threads can be compacted in order to improve the texture of the obtained edible food product. The compaction can be done during at least 60 seconds, preferably at least 10 minutes, more preferably at least one hour, even more preferably at least two hours.

The compaction can be done at room temperature but is preferably done at a temperature of at most 8° C., preferably at most 5° C.

The compaction can involve several assemblies of edible protein thread. In that case, the edible food product is formed by several assemblies of edible protein thread. The compaction can be done in pressing molds which will determine the shape of the final product. For example, the assembly of edible thread can be compacted under a pressure of at least 0.01 kg/cm²; or at least 0.05 kg/cm²; preferably at least 0.1 kg/cm² or at least 0.5 kg/cm² and more preferably at least 0.10 kg/cm² or at least 0.15 kg/cm².

The pressure is preferably applied in a direction perpendicular to the direction of the protein threads.

A method 100 according to the invention can comprise a step of transforming the assembly of edible protein threads.

This step is in particular designed to prepare the edible protein threads associated with the fatty matrix so that they are suitable for the subsequent steps, in particular for the conditioning of an edible food product which can be an edible meat substitute. Also, the step of transforming the edible protein threads associated with the fatty matrix can also comprise a combination of the edible protein threads associated with the fatty matrix with another food matrix, such as a carbohydrate matrix.

For example, the assembly of edible protein threads can undergo further processing such as marination, crushing, squishing, braiding, cutting, mincing, grinding, mixing, shredding, squeezing, dosing, molding, pressing, 3D printing, extruding baking, cooling, freezing or cooking steps such as smoking, roasting, frying, surface treatment, coating, injection of solutions such as blood substitutes (e.g. synthetic myoglobin or heme protein synthesized by fermentation or by microorganism), or also combination with other ingredients, in order to produce an edible food product which mimics known conventional meat products. In particular, the edible product can be an alternative product to the meat which aims to imitate a known meat product, transformed or not.

As shown in FIG. 1, a method according to the invention can comprise a step of conditioning 190 the edible food product.

This step 190 is in particular designed to obtain an edible food product, comprising the assembly of protein threads, having meat-like properties, such as meat-like organoleptic properties in particular meat-like texture or flavor.

According to the invention, the step of conditioning 190 the edible food product can comprise steps such as steps that affect water content, shape, texture, flavor or even shelf life of the edible food.

For example, according to the invention, the step of conditioning 190 the edible food product can comprise steps such as drying, desiccation, dehydration, lyophilization, filtering or a combination thereof.

For example, according to the invention, the step of conditioning 190 the edible food product can comprise steps such as sterilization or pasteurization.

Finally, according to the invention, the step of conditioning 190 the edible food product can comprise steps such as cooling, refrigeration, deep-freezing, packaging or a combination thereof.

In another aspect, the invention relates to an edible food product obtainable from a method 100 according to the invention. Preferably, the edible food product comprises an assembly of edible protein thread(s) within which is positioned a fatty matrix. More preferably, the edible food product has been obtained by a method according to the invention.

Several embodiments, whether preferred or not preferred, have been described here before in connection to the method 100 according to the invention to produce the edible food product of the invention. Hence, the edible food product according to the invention (e.g. assembly of protein threads and fatty matrix) may comprise, alone or in combination, each of the features described above in connection with a method according to the invention and any of its above-mentioned steps.

The edible food product according to the invention comprises advantageously marbled fat domains. The marbling can be characterized using image analysis by identifying the fat phase domains and calculating the ratio of the fat phase domain area versus fat phase domain interface length.

The edible food product according to the invention comprises advantageously marbled fat domains. Advantageously, an edible food product according to the invention is characterized by a fat distribution such that its fractal dimension is of at least 1.1, preferably at least 1.6, more preferably at least 2.1 and even more preferably at least 2.6. The fractal dimension is measured based on a photograph of a slice of the edible food product using image analysis and an improved box-counting algorithm. Briefly, binary image is covered with small square box of different side lengths. Side length r and a total of not empty small box N(r), meet the relationship test: D_{b}=−lgN(r)/lg(1/r) where D_{b} is the box dimension. Scale size r is usually 2\hat{ }n. A series of non-empty box numbers are acquired in the different proportion sizes of r. The reciprocal of r, and the number of these non-empty boxes, are set in double logarithmic coordinates, by least squares linear to fit them, then the absolute value of slope is the box dimension. When the image size could not be a square side length divisible, then rounding the excess with only small “margins” section, thus reducing outside interference. It gives the value “1” pixel of binary chart, accounting for the entire map of the area proportion. This reflects objectively the number of marble patterns.

In particular, the proteins of the edible protein threads are selected among plant proteins, microbial proteins, algae proteins, animal proteins, fungal proteins, and a combination thereof. Preferably, the proteins of the edible protein threads comprise at least non-human animal proteins, said non-human animal proteins being cultivated non-human animal cell proteins. Advantageously, this edible protein thread has an improved meat-like flavor and/or meat-like texture compared to edible protein thread made from only plant proteins.

The edible protein thread is preferably a heat-resistant protein thread, said heat-resistant protein thread being formed from one or more texturizing molecule(s) capable of creating a heat-resistant thread. More preferably, the edible protein thread comprises a polyelectrolyte combined with a suitable polyvalent ion to form the heat-resistant protein thread.

An edible protein thread associated with the fatty matrix according to the invention can have been produced from a cross-linking molecule used either in the protein matrix and/or the fatty matrix. Preferably, an edible food product according to the invention can have been produced from a protein matrix comprising one of either the polyvalent ion or the polyelectrolyte, and a fatty matrix which comprises the other. In particular, an edible protein thread combined with the fatty matrix according to the invention can have been produced from a protein matrix comprising the polyelectrolyte or from a protein matrix comprising the polyvalent ion. In an embodiment, the fatty matrix and/or the protein matrix further comprise a cross-linking molecule, in addition to the polyelectrolyte or the polyvalent ion.

Advantageously, the edible protein thread associated with the fatty matrix has been produced from non-human cultivated animal cells. Hence, as it is detailed hereafter, the edible protein thread combined with the fatty matrix according to the invention can comprise intact cultivated cells, disrupted cultivated cells and/or extracts of cultivated cells (such as extracts of disrupted cultivated cells), said cells being cultivated cells from an organism of the Animalia kingdom excluding human. However, considering the preferred embodiments of the method according to the invention to produce the edible protein threads, the edible protein thread associated with the fatty matrix may not contain intact cultivated cells.

An edible food product comprising edible protein threads associated with the fatty matrix can comprise a ratio in weight of fatty matrix on protein threads from 0.20 to 1.8, preferably from 0.25 to 1.6, more preferably from 0.3 to 1.4 and even more preferably from 0.4 to 1.2.

The edible protein thread associated with the fatty matrix can comprise at least 0.1% in weight of polyelectrolyte compared to the total wet weight of the protein thread. Preferably, the edible protein thread combined with the fatty matrix can comprise at least 0.2% in weight of polyelectrolyte compared to the total wet weight of the protein thread; more preferably at least 0.3% in weight, even more preferably at least 0.4% in weight, compared to the total wet weight of the protein thread.

The edible protein thread associated with the fatty matrix can comprise at most 15% in weight of polyelectrolyte compared to the total wet weight of the protein thread. Preferably, the edible protein thread combined with the fatty matrix can comprise at most 10% in weight of polyelectrolyte compared to the total wet weight of the protein thread; more preferably at most 5% in weight, even more preferably at most 3% in weight, compared to the total wet weight of the protein thread.

The edible protein thread associated with the fatty matrix can comprise from 0.1% to 15% in weight of polyelectrolyte compared to the total wet weight of the protein thread. Preferably, the protein thread can comprise from 0.2% to 10% in weight of polyelectrolyte compared to the total wet weight of the protein thread; more preferably from 0.3% to 5% in weight, even more preferably from 0.4% to 3% in weight, compared to the total wet weight of the protein thread.

The edible protein thread associated with the fatty matrix according to the invention has preferably a shape and/or mechanical properties that allow it to mimic the behavior of a conventional meat from a slaughtered animal when cooked and tasted.

For example, an edible protein thread associated with the fatty matrix according to the invention has a length of at least 2 mm, preferably at least 10 mm, more preferably at least 50 mm, even more preferably at least 100 mm.

For example, an edible protein thread associated with the fatty matrix according to the invention has a diameter of at most 4 mm, preferably at most 2 mm, more preferably at most 1 mm, even more preferably at most 0.5 mm.

Advantageously, the edible food product according to the invention can be considered as an ingredient for an alternative to conventional meat products from a slaughtered animal or an alternative to conventional meat products from a slaughtered animal as such.

An edible food product according to the invention can for example be a ready-to-eat food product that can be consumed directly, or eventually after a processing step (e.g. crushing, squishing, braiding, cutting, grinding, mixing, shredding, squeezing, dosing, molding, pressing, 3D printing, extruding baking or cooking steps such as smoking, roasting, frying, surface treatment, and/or coating) and/or a cooking step. An edible food product according to the invention can also be an intermediate product to be used in combination with other products to produce a ready-to-eat food component. In particular, the edible food product according to the invention can be an alternative product to the meat from a slaughtered animal which aims to imitate a conventional meat product (e.g. steak, sausage, pâté . . . ). As it is illustrated in examples, an edible food product according to the invention can exhibit an improved meat-like texture and/or meat-like flavor compared to an edible meat alternative food product made from plant proteins.

As it has been mentioned, the edible food product according to the invention can be a finished product or an ingredient for food processing. Preferably, the edible food product according to the invention mimics an animal-derived edible food product. The edible food product according to the invention can be a cooked, a non-cooked or a precooked product.

For example, the edible food product according to the invention is a cooked edible food product or a pre-cooked edible food product. For example, the edible food product is precooked to be further pan-fried. Alternatively, the edible food product is a non-cooked product.

In another aspect, the invention relates to a system 1 for producing an edible food product comprising edible protein threads associated with the fatty matrix.

In particular, a system 1 according to the invention can comprise a first container 20 adapted to include a protein matrix and a second container adapted to include a fatty matrix.

The protein matrix container 20 (first container) and the fatty matrix container (second container) can be made of food grade plastics, ceramics, glasses, silicons, stainless steel, or combination thereof. The container(s) can be associated with a temperature controller configured to measure and modify the temperature of the matrix. The container can be associated with a pressure controller configured to measure the pressure inside the container.

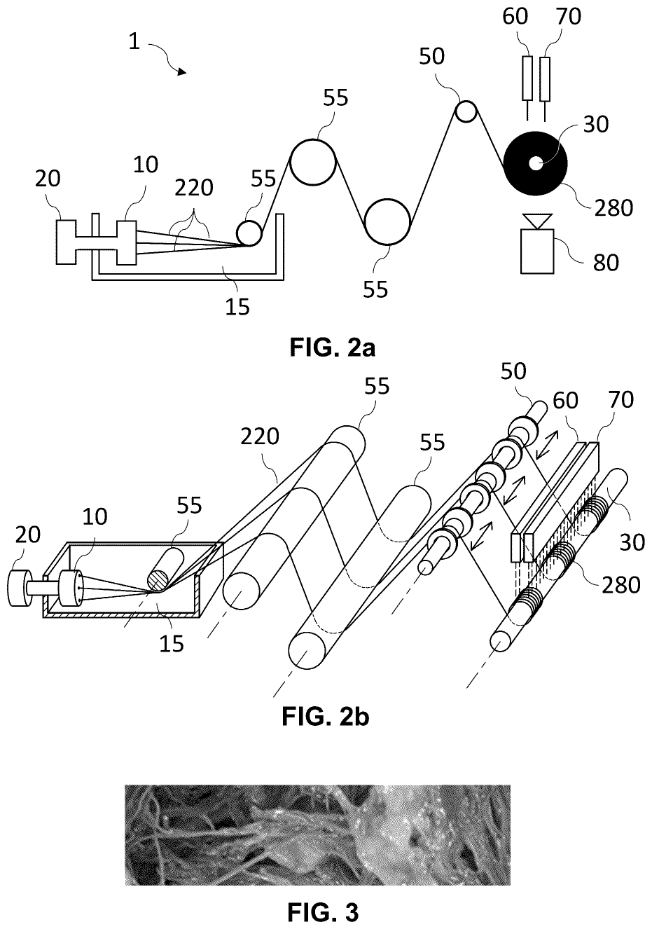

In particular, the system 1 according to the invention can comprise a threading device 10 configured to process the protein matrix contained in the first container 20 to form one or more edible protein thread(s) 220. As illustrated in FIG. 2a and FIG. 2b, the system 1 according to the invention comprises a coagulation bath 15. Advantageously, the coagulation bath 15 is arranged to be able generate protein threads.

In particular, the system 1 according to the invention can comprise a guiding device 50 configured to guide the one or more edible protein thread(s) on a collecting device 30. Preferably, the guiding device 50 and the collecting device 30 are configured to cooperate so as to form an assembly of edible protein thread(s) 280. In particular, the guiding device 50 can comprise one or more housing for the edible protein thread(s) 220. Preferably when the guiding device 50 comprises more than one housing, the housings are arranged in such a way that they can move independently with respect to the collecting device 30. For example, the guiding device 50 can be arranged to move in horizontal direction with respect to the collecting device 30. In particular, the guiding device 50 and the collecting device 30 are parallel to each other, and they rotate in the same direction at the same speed. The guiding device 50 is advantageously configured to move horizontally across the width of the collecting device 30 to guide the fiber across the width of the collecting device 30 while maintaining tension and alignment. The guiding device 50 is preferably controlled through an electronic system like a stepper motor or servomotor. In particular, the guiding device 50 can comprise several parts capable of independent movement and thus capable of manipulating and guiding several edible protein threads 220 independently on the collecting device 30.

Also, the system 1 can comprise several rollers 55 used to manipulate and control the edible protein thread(s) 220 during various stages of the production process. The specific arrangement of these rollers 55, such as in-feed rollers, tension control rollers, deflection rollers, twist rollers, drawing rollers can be used to maintain tension, change edible protein thread(s) direction, twist, stretch, or guide the edible protein thread(s) onto a collecting device 30.

In particular, the system 1 according to the invention can comprise a fat dispensing device 60 configured to add the fatty matrix on the one or more edible protein thread(s) 220 so that the fatty matrix is positioned within the assembly of edible protein thread(s) 280. Preferably the fat dispensing device 60 is configured for solid fat deposition or liquid fat deposition. The fat dispensing device 60 is particularly suitable for use in food applications, and can comprise pressurized chamber(s), plunger(s), and dispensing nozzle(s). In particular, the system 1 according to the invention can comprise an elastomeric protein matrix dispensing device 70 configured to add the elastomeric protein matrix on the one or more edible protein thread(s) 220 so that the elastomeric proteins are positioned within the assembly of edible protein thread(s) 280. Preferably, the elastomeric protein matrix dispensing device 70 is particularly suitable for use in food applications, and can comprise pressurized chamber(s), plunger(s), and dispensing nozzle(s).

The fat dispensing device 60 and the elastomeric dispensing device 70 can be independent or combined in one device. Preferably the dispensing devices 60, 70, either independent or combined, comprise a pressure applicator, such as a plunger, designed to exert pressure on the matrix within the chamber, which may be adjusted to accommodate different types of matrix and deposition requirements. The pressure applicator may be operated manually or through a motorized system, depending on the specific application and production volume. The dispensing nozzle(s) can be linked to the chamber and designed to release the matrix in a controlled manner onto the protein threads. The nozzle may be designed to allow for different types of deposition patterns, such as a uniform coating, a drizzle, or a spray. The nozzles are advantageously coupled to a flow stopper, for example controlled with an actuator, capable of quickly stopping the flow of the matrix.

Preferably, the system 1 according to the invention can further comprise a cooling device. Preferably, the system 1 according to the invention can further comprise a cutting or a slicer device or a packaging device.

The system 1 can also comprise several components dedicated to operating the described devices and preferably dedicated to the generation of marbling patterns in the edible food product. For example, the system 1 can comprise a computing device, feedback sensors, and actuators.

For example, a computing device may be a personal computer, a network storage device, or any other suitable device and may vary in size, shape, performance, functionality, and price. The computing device may include one or more processing resources such as a central processing unit (CPU) or hardware or software control logic, memory component such as random-access memory (RAM), ROM, and/or other types of nonvolatile memory. Additional components of the computing device may include one or more disk drives, one or more network ports for communication with external devices as well as various input and output (I/O) devices, such as a keyboard, a mouse, and a video display. The computing device may also include one or more buses operable to transmit communications between the various hardware components. The processor(s) usually serve as the central processing unit. They are responsible for receiving input from sensors, processing the data, and generating appropriate control signals for the actuators.

The memory component may comprise any computer readable medium known in the art including, for example, a volatile memory, such as a static random-access memory (SRAM) and a dynamic random-access memory (DRAM), and/or a non-volatile memory, such as read-only memory, flash memories, hard disks, optical disks and magnetic tapes. The memory component may include a plurality of instructions or modules or applications for performing various functions. Thus, the memory component can implement routines, programs, or matrix-type data structures. Preferably, the memory component may comprise a medium readable by a computing system in the form of a volatile memory, such as a random-access memory (RAM) and/or a cache memory. The memory component, like the other modules, can for example be connected with the other components of the system 1 via a communication bus and one or more data carrier interfaces.

Moreover, the memory component is preferably configured to store instructions capable of implementing the method according to the invention, according to its preferred or non-preferred embodiments. The memory component may include any number of databases or similar storage media that can be queried from the processor as needed to perform the method of the invention. In particular, the memory component can be used to store sensor data, control algorithms, and other relevant information. Memory module can comprise non-volatile memory, that retains data even when power is lost, making it suitable for storing essential system parameters, control algorithms, and other permanent data; and volatile memory, used for temporary storage of data, such as sensor readings and intermediate calculations during the control process.

The feedback sensors provide real-time information on various parameters, such as protein threads tension, collecting device speed, guiding device position, and winding parameters.

The actuators are responsible for executing the control commands generated by the processor(s). They can include motors, solenoids, or pneumatic/hydraulic cylinders. Actuators can be used to control the collecting device's movement, adjust the guiding device's position, regulate the traverse mechanism, and maintain proper protein thread tension.

The communication interfaces facilitate data exchange between the processor(s), sensors, actuators, and other peripheral devices.

### EXAMPLES

The invention is further described in detail by reference to the following experimental examples. These examples are provided for purposes of illustration only and are not intended to be limiting unless otherwise specified. Thus, the invention should in no way be construed as being limited to the following illustrative examples, but rather, should be construed to encompass any and all variations which become evident as a result of the teaching provided herein.

Without further description, it is believed that one of ordinary skills in the art can, using the preceding description and the following illustrative examples, make and utilize the products of the present invention and practice the claimed methods. The following examples, therefore, specifically point out the preferred embodiments of the present invention and are not to be construed as limiting in any way the remainder of the disclosure.

### Materials and Methods

### Ingredients

Sodium alginate food grade powder, E 401
Methylcellulose E461
Chitosan no. CAS 9012-76-4
Calcium chloride no. CAS 10043-52-4
NaCl
Transglutaminase (TGase) Powder—125 U/g
Elastin—Sigma
Recombinant collagen—Sigma
Gluten
konjac glucomannan
Flavoring solution

### Fat

Plant fat and/or fermented fat can be obtained through mechanical, enzymatic or chemical extraction from seeds or from other parts of fruit such as palm oil and avocado butter. It can then be purified and, if required, refined or chemically altered. Many commercial references can be used such as a mix of CremoFLEX® L and CremoFLEX® E. Alternatively, fermented fat produced by microalgae such as Bacillariophyceae, Chlorophyceae, Eustigmatophyceae, Rhodophyceae or Conjugatophyceae can be used. The chemical analysis, in particular triglycerides or fatty acid concentrations, of the fatty substances can be carried out using the analysis and quantification methods known to those skilled in the art (e.g. using ISO 12966).

### Cells Culture & Preparation

Bovine cells are bovine cells obtained from biopsies or cultivated cells. Cultivated cells can be bovine embryonic stem cells initially isolated from bovine embryos and adapted to grow in suspension in the serum free and growth factors free medium. These cells are characterized by their property to grow in suspension at a larger scale in bioreactors.

The bovine cells are cultivated in a 30 L stainless steel bioreactor at 37° C., pH 7.1 regulated with CO₂ injection under constant stirring at 50 rpm. Four days post seeding, cells are collected from the bioreactor, submitted to a two-step centrifugation and the dry pellets are weighed.

A protein dosage can be conducted using a Bradford method on a sample of the harvested cells.

The moisture content can be measured and can be adjusted. Cells can be used as such. However, an additional step such as protein extraction can be performed on harvested cultivated cells.

### Protein Matrix Preparation

The protein matrix is prepared by mixing the ingredients following mix matrices.

The protein matrix is homogenized using a homogenizer (8000 rpm, 60 s).

### Fatty Matrix Composition & Preparation

The fatty matrix is prepared by mixing the ingredients following mix matrices hereunder described. Fats are added either liquid, solid or both.

The fatty matrix is homogenized using a homogenizer (8000 rpm, 60 s).

### Elastomeric Protein Matrix Composition & Preparation:

The elastomeric protein matrix is prepared by mixing the gluten and/or collagen eventually with other polymer(s) such as konjac glucomannan following mix matrices hereunder described. The elastomeric protein matrix is homogenized using a homogenizer (8000 rpm, 60 s).

The elastomeric protein matrix is either used in a liquid form, in a form of a solid film, or in a form of a sol-gel film.

### Coagulation Composition & Preparation:

The coagulation composition is a coagulation bath comprising 0.5% w/w of calcium chloride dissolved in distilled water, so 0.17% w/w of a polyvalent ion such as calcium.

### Contacting the Protein Matrix and Fatty Matrix to Produce the Edible Food Product

Protein threads are spinned using a syringe pump (Chemyx), a 10 ml syringe equipped with 18 G (0.8 mm) or 14 G (1.6 mm) needle or a spinneret comprising several holes in a coagulation bath (the injection rate is fixed at 5 mL/min). The protein threads are further guided on a collecting device where they are contacted with the fatty matrix.

### Mechanical Test

Protein threads are evaluated by tensile testing using a texturometer (Ametek LS1 equipped with a 10 kg load cell). Briefly, protein threads are subjected to an elongation until failure and the force is recorded as a function of the elongated distance. At failure, the measured force drops sharply.

The extension rate is 100 mm/min and measurements are performed on 6 samples for each condition.

### Texture Profile Analysis

A texture profile analysis can be conducted to compare the texture of an edible meat substitute comprising edible protein threads and a fatty matrix having controlled fat marbling according to the invention to the texture of other food products.

Typically, each sample is cut into 2 cm square cubes, then pan-fried on a heating plate at 200° C. for 2 min per side until reaching a core temperature of 55±2° C. TPA measurements (6 repetitions per product) are performed using a texturometer equipped with a 500N load cell and a compression plate probe of 75 mm of diameter.

Samples are subjected to two cycles of compression to 75% of their height with 10 s elapsed time. Measurements are performed at 20° C. and the compression direction is parallel to the fiber's orientation.

### Fat Release Properties

The fat release phenomenon during cooking and chewing is important when evaluating the textural properties of meat products, especially high fat content meat products such as marbled beef. Also, the fat release phenomenon can be correlated to the fat-explosion and mouthfeel that consumers experience while chewing.

As an edible food product according to the invention comprises edible protein threads and a fatty matrix having controlled fat marbling, a way of evaluating its ability to mimic the behavior of a conventional food product is to evaluate the quantity of leaked fat during a pan-fried style cooking.

Fat release measurements are conducted to compare the leaked fat. Each sample is cut into 2 cm square cubes, then pan-fried on a customized heating plate at 200° C. for 2 min per side until reaching a core temperature of 55±2° C.

The fat release value at cooking is preferably the mean value obtained from at least 5 independent samples. For example, fat release can be measured using a first paper napkin weighed, then used to collect and absorb the fat that leaked on the cooking surface after a cooking step. The difference of weight of the first paper napkin before and after pan-frying equals the weight of fat released during cooking.

The capacity of the samples to release fat during cooking can be expressed in w/w % using the following equation:

$$( ( sample weight before cooking - sample weight after cooking ) / sample weight before cooking ) * 100$$

The fat release value after compression is preferably the mean value obtained from at least 5 independent samples. For example, fat release can be calculated by measuring the weight of the sample before and after the double compression test. Samples are subjected to two cycles of compression to 75% of their height with 10 s elapsed time. Measurements are performed at 20° C. and the compression direction is parallel to the fiber's orientation.

The difference of weight of the samples before and after pan-frying equals the weight of fat released during compression. This value correlates with sensory perception by the panelist to the fat release in mouth when consuming the edible food product.

The capacity of the samples to release fat during compression can be expressed in w/w % using the following equation:

$$( ( sample weight before compression - sample weight after compression ) / sample weight before compression ) * 100$$

### Sensory Evaluations

Food samples are anonymized before tasting. Additionally, panelists are offered water for rinsing their mouth between samples and a cracker, to reset flavor receptors.

Panelists evaluate the overall liking and meat-like organoleptic properties of the edible food product samples by tasting. For example, to evaluate beef substitutes, panelists assess beef-meat flavor and texture (tenderness, cohesiveness, oiliness and juiciness).

### Influence of the Presence or Absence of a Fatty Matrix on the Edible Food Product

The fatty matrix plays the role of a fatty phase in the final food product. Hence the fatty matrix needs to interact effectively with the protein matrix and should reproduce a meat-like texture and appearance, in particular of the fatty part of meat, which is complex.

The protein matrix is prepared by mixing: 17.6% animal proteins from cells or cell extracts wt %; 0% fatty matrix; 1% NaCl; 1% sodium alginate; 1% TGase; and 79.4% water.

The protein matrix is used in a spinneret to induce a flow of the protein matrix coming into contact with the coagulation bath.

For a first preparation, the bundles are harvested from the spooler by a transversal cut, wrapped in paper film and pressed for 30-60 min (rectangular pressing mould 5×10 cm). They are stored at 4° C. overnight until further evaluation.

For a second preparation, while the protein threads are collected on a spooler, a fatty matrix (95% plant fat; 5% water) is applied on the collected protein threads before they are covered by a new portion of protein threads. The fatty matrix is applied in a ratio of fatty matrix weight to protein threads weight in the assembly of 1. The bundles comprising an assembly of protein threads and a fatty matrix are collected from the spooler by a transversal cut, wrapped in paper film and pressed for 30-60 min (rectangular pressing mold 5×10 cm). They are stored at 4° C. overnight until further evaluation.

### Results and Conclusion

Evaluation based on sensory analysis is conducted after cooking. The edible food product that is produced in these experiments needs to reproduce an appropriate appearance in cold conditions and an appropriate mouthfeel in hot conditions, mimicking the mouthfeel whilst eating an animal fatty product, in particular a marbled meat.

The first preparation is a comparative example. It is not related to the invention. The edible food product from this preparation does not have a juiciness expected from a meat substitute. It was very dry in the mouth compared to the invention products.

Conversely, the second preparation allows to obtain an edible food product comprising protein threads assembled with the fatty matrix, said edible food product having a juiciness expected from a meat substitute. The addition of the fatty matrix through the collecting device can be used to generate a controlled marbling pattern.

### Influence of the Addition Method of the Fatty Matrix on the Edible Food Product

The fat can be added to the edible food product as a fatty matrix on the protein threads as in the invention or can be used mixed in the protein matrix.

A first protein matrix is prepared by mixing: 17.6% animal proteins from cells or cell extracts wt %; 10% fatty matrix; 1% NaCl; 1% sodium alginate; 1% TGase; and 69.4% water.

A second protein matrix is prepared by mixing: 17.6% animal proteins from cells or cell extracts wt %; 0% fatty matrix; 1% NaCl; 1% sodium alginate; 1% TGase; and 79.4% water.

Both of the protein matrices are used in a spinneret to induce a flow of the protein matrix coming into contact with the coagulation bath.

With the first protein matrix, the bundles are harvested from the spooler by a transversal cut, wrapped in paper film and pressed for 30-60 min (rectangular pressing mold 5×10 cm). They are stored at 4° C. overnight until further evaluation.

With the second protein matrix, while the protein threads are collected on a spooler, the fatty matrix (95% plant fat; 5% water) is applied on the collected protein threads before they are covered by a new portion of protein threads. The quantity of fatty matrix applied is determined so that, for the first and the second preparation, the fat to protein ratio in the edible food product produced are the same.

The bundles comprising an assembly of protein threads and a fatty matrix are collected from the spooler by a transversal cut, wrapped in paper film and pressed for 30-60 min (rectangular pressing mold 5×10 cm). They are stored at 4° C. overnight until further evaluation.

### Results and Conclusion

Evaluation based on sensory analysis is conducted after cooking. The edible food product that is produced in these experiments needs to reproduce an appropriate appearance in cold conditions and an appropriate mouthfeel in hot conditions, mimicking the mouthfeel whilst eating an animal fatty product, in particular a marbled meat.

The first preparation is a comparative example. It is not related to the invention. The edible food product from this preparation does not have a juiciness expected from a meat substitute.

Conversely, the second preparation allows to obtain an edible food product comprising protein threads assembled with the fatty matrix, said edible food product having a juiciness expected from a meat substitute. Also, the addition of the fatty matrix through the collecting device can be used to generate a controlled marbling pattern.

### Influence of the Addition of Elastomeric Protein Matrix on the Edible Food Product

A protein matrix is prepared by mixing: 17.6% animal proteins from cells or cell extracts wt %; 1% NaCl; 1% sodium alginate; 1% TGase; and 79.4% water.

The protein matrix is used in a spinneret to induce a flow of the protein matrix coming into contact with the coagulation bath. While the protein threads are collected on a spooler, a fatty matrix (95% plant fat; 5% water) is applied on the collected protein threads.

For a first preparation, while the protein threads are collected and the fatty matrix is applied, an elastomeric protein composition is also applied in a liquid form on the protein threads. For a second preparation, while the protein threads are collected and the fatty matrix is applied, an elastomeric protein composition is also applied on the protein threads in a form of an already formed network. For a third preparation, there is no addition of an elastomeric protein matrix.

The bundles comprising an assembly of protein threads and a fatty matrix are collected from the spooler by a transversal cut, wrapped in paper film and pressed for 30-60 min (rectangular pressing mold 5×10 cm). They are stored at 4° C. overnight until further evaluation.

### Results and Conclusion

Evaluation based on sensory analysis is conducted after cooking. All preparations according to the invention. The third preparation allows to obtain an edible food product comprising protein threads assembled with the fatty matrix, said edible food product having a juiciness expected from a meat substitute. However, the addition of an elastomeric protein matrix in the first preparation and in the second preparation improves the visual effect by creating small fibers when pulling the piece of meat in a direction perpendicular to the fiber alignment (like in conventional meat). Also, the mouthfeel is improved by this elastomeric protein matrix thanks to an improvement of the fiber-fiber and fiber-fat attachment.

Also, the first preparation and in particular the second preparation can also exhibit an improved mouthfeel and juiciness compared to the third preparation.

### Influence of the Composition of the Fatty Matrix in Fatty Acids

Several fatty matrix compositions are evaluated in order to find the ones having the consumer's approval. Testing is conducted on cold (about 5° C.) and hot (consumption being at about 40° C.) conditions. The fatty matrix that is produced in these experiments needs to produce an appropriate mouthfeel in cold and hot conditions, mimicking the mouthfeel whilst eating a meat product.

A protein matrix is prepared by mixing: 17.6% animal proteins from cells or cell extracts wt %; 0% fatty matrix; 1% NaCl; 1% sodium alginate; 1% TGase; and 79.4% water.

While the protein threads are collected on a spooler, the fatty matrix is applied on the collected protein threads before they are covered by a new portion of protein threads. The quantity of fatty matrix applied is determined so that the fat to protein ratio in the edible food product produced is fixed for all preparation.

The bundles comprising an assembly of protein threads and a fatty matrix are collected from the spooler by a transversal cut, wrapped in paper film and pressed for 30-60 min (rectangular pressing mold 5×10 cm). They are stored at 4° C. overnight until further evaluation at cold or hot conditions.

### Influence of the Composition of the Fatty Matrix

Table 1 below shows preferred compositions according to the invention. The table 1 below shows the quantity used for each of the fatty matrix preparations.

TABLE 1

| Ingredients | | | |
|---|---|---|---|
| (% w wet fatty matrix) | 1A | 1B | 1C |
| Plant Fat | 96.20% | 92.20% | 84.50% |
| (% w wet fatty matrix) | | | |
| including triglycerides | 50.00% | 84.00% | 92.00% |
| (% w plant fat) | | | |
| Beef cells | 0% | 4.2% | 12.70% |
| (% w wet fatty matrix) | | | |
| including beef proteins | 0% | 0.60% | 1.80% |
| (% w wet fatty matrix) | | | |
| Salt | 1.00% | 1.00% | 1.00% |
| (% w wet fatty matrix) | | | |
| Flavoring solution (% w | 1.80% | 1.80% | 1.80% |
| wet fatty matrix) | | | |
| Water | 1.00% | 0.80% | 0% |
| Total (% w) | 100.00% | 100.00% | 100.00% |

The edible food product made using the fatty matrix compositions 1A, 1B, & 1C have a fat texture expected from the fat of a meat substitute. In particular, the fat from the preparation 1B may have a better texture at 40° C. compared to the one from the composition 1A. Moreover, the composition 1C may show a lower release of fat during cooking compared to the composition 1B. Without being limited by theory it could be linked to a higher concentration of triglycerides and/or proteins.

### Influence of the Fatty Acid Composition of the Plant or Fermented Fat

The fatty acid composition of the fat used in the fatty matrix of the edible food product of the invention is of great importance for the texture obtained.

Table 2 below shows fatty matrix compositions which may solve the technical problem addressed by the present invention.

TABLE 2

| Ingredients | 2A | 2B | 2C | 2D |
|---|---|---|---|---|
| Plant Fat | 91.70% | 91.70% | 91.70% | 91.70% |
| (% w wet fatty matrix) | | | | |
| Including Triglycerides | 96.50% | 97.00% | 97.00% | 97.00% |
| (% w plant fat) | | | | |
| Palmitic acid | 31.00% | 35.00% | 31.00% | 20.00% |
| (% w plant fat) | | | | |
| Stearic acid | 4.00% | 0.00% | 4.00% | 15.00% |
| (% w plant fat) | | | | |
| Oleic acid | 58.00% | 55.00% | 55.00% | 55.00% |
| (% w plant fat) | | | | |
| Saturated C16-C18 | 35.00% | 35.00% | 35.00% | 35.00% |
| fatty acids | | | | |
| (% w plant fat) | | | | |
| Monounsaturated C18 | 58.00% | 55.00% | 55.00% | 55.00% |
| fatty acids | | | | |
| (% w plant fat) | | | | |
| Polyunsaturated C18 | 3.50% | 7.00% | 7.00% | 7.00% |
| fatty acids | | | | |
| (% w plant fat) | | | | |
| Methylcellulose | 1.00% | 1.00% | 1.00% | 1.00% |
| (% w wet fatty matrix) | | | | |
| Salt | 1.00% | 1.00% | 1.00% | 1.00% |
| (% w wet fatty matrix) | | | | |
| Flavoring solution | 1.30% | 1.30% | 1.30% | 1.30% |
| (% w wet fatty matrix) | | | | |
| Water | 5.00% | 5.00% | 5.00% | 5.00% |
| Total | 100% | 100% | 100% | 100% |
| (% w wet fatty matrix) | | | | |

The tests carried out from variable concentrations of fats and triglycerides make it possible to assess the importance of the composition on the organoleptic satisfaction brought to the consumer.

The edible food product using the fatty matrix composition 2C and 2D give the best results with good results for preparation 2A. For the preparation 2B, the texture is good at low temperature but just acceptable at high temperature.

### Evaluation of the Effect of the Protein Content in the Protein Matrix on the Protein Threads According to the Invention

The objective of this experiment is to illustrate the effect of protein content on the mechanical properties of protein threads. The protein matrix composition is prepared by mixing the ingredients following table 3.

TABLE 3
Ingredients of the protein matrix composition

| | Animal proteins | | | | Sodium |
|---|---|---|---|---|---|
| | from cells or cell | Water | Liquid oil | NaCl | alginate |
| Ref | extracts wt % | wt % | wt % | wt % | wt % |
| 3A | 7.1 | 80.90 | 10 | 1 | 1 |
| 3B | 10.56 | 77.44 | 10 | 1 | 1 |
| 3C | 13.20 | 74.80 | 10 | 1 | 1 |
| 3D | 17.6 | 70.40 | 10 | 1 | 1 |

The protein matrix is used in a spinneret to produce several flows of protein matrix coming into contact with the coagulation bath. The protein threads are collected after 2 min rest in the coagulation bath.

While the protein threads are collected on a spooler, the fatty matrix (95% plant fat; 5% water) is applied on the collected protein threads before they are covered by a new portion of protein threads. The quantity of fatty matrix applied is determined so that the fat to protein ratio in the edible food product produced is the same. The assembly of protein threads and a fatty matrix is collected from the spooler by a transversal cut, wrapped in paper film and pressed for 30-60 min (rectangular pressing mold 5×10 cm) and stored at 4° C. overnight. The protein threads were then separated with care to not damage them and characterized by tensile tests.

### Results & Conclusion

Protein threads prepared with the protein matrix having a protein content of 10.56 wt % (3B), 13.20 wt % (3C) or 17.6 wt % (3D) have significant improved strain at break, load at break, and tensile stress compared to the ones having a protein content of 7.1 wt % (3A).

In particular, protein threads prepared with the protein matrix having a protein content of 17.6 wt % (3D) have +6% strain at break, +37% load at break, and +36% tensile stress compared to the ones having a protein content of 10.56 wt % (3B).

Hence, when forming protein threads according to the invention, one should preferably use a protein matrix having at least 10 wt % of protein compared to the total wet weight of the protein matrix and preferably at least 13 wt %, more preferably at least 17 wt % of protein compared to the wet weight of the protein matrix.

### Evaluation of the Effect of the Protein Origin in the Protein Matrix on the Protein Threads

The objective of this experiment is to evaluate the effect of the protein origin on the mechanical properties of protein threads using tensile testing.

The protein matrix composition is prepared by mixing the ingredients following table 4a.

TABLE 4a
Ingredients of the protein matrix (all ingredients excepted water
are expressed in weight/total weight of the composition)

| Ref | 4-80 | 4-40 | 4-0 |
|---|---|---|---|
| Animal proteins from cells or cell | 17.6 | 8.8 | 0 |
| extracts wt % | | | |
| Including myofibrillar proteins wt % | 8.8 | 4.4 | 0 |
| Plant proteins wt % | 0 | 8.8 | 17.6 |
| Proteins total (wt %) | 17.6 | 17.6 | 17.6 |
| Myofibrillar protein on total proteins | 0.5 | 0.25 | 0 |
| Liquid oil wt % | 10 | 10 | 10 |
| NaCl wt % | 1 | 1 | 1 |
| Sodium alginate wt % | 1 | 1 | 1 |
| Water wt % | 70.4 | 70.4 | 70.4 |

The plant proteins used in the protein matrix are soy proteins.

The protein matrices are used in a spinneret to induce a flow of the protein matrix coming into contact with the coagulation bath. The protein threads are collected after 2 min rest in the coagulation bath.

While the protein threads are collected on a spooler, the fatty matrix (95% plant fat; 5% water) is applied on the collected protein threads before they are covered by a new portion of protein threads. The quantity of fatty matrix applied is determined so that the fat to protein ratio in the edible food product produced is the same. The assembly of protein threads and a fatty matrix is collected from the spooler by a transversal cut, wrapped in paper film and pressed for 30-60 min (rectangular pressing mold 5×10 cm) and stored at 4° C. overnight. The protein threads were then separated with care to not damage them and characterized by tensile tests.

### Results & Conclusion

The mechanical properties of the protein threads are illustrated in the table 4b below.

TABLE 4b
Results from the tensile testing

| | Strain | Load | Tensile | Young's |
|---|---|---|---|---|
| Ref | at break | at Break | Stress | modulus |
| 4-80 | 239% | 321% | 314% | 129% |
| 4-40 | 223% | 205% | 200% | 92% |
| 4-0 | 100% | 100% | 100% | 100% |

The results of the tensile tests are normalized over the values obtained for the protein threads made with only plant protein (4-0).

Protein threads prepared with animal proteins from cells or cell extracts (4-80; 4-40) have higher resistance to traction (tensile testing) than the ones prepared with soy proteins in the same conditions. The observed improvement is a factor of 2 when the animal proteins from cells or cell extracts (4-40) are used in combination with plant proteins (resulting in a concentration of myofibrillar proteins above 4%) and at least a factor 3 when a concentration above 15% of animal proteins from cells or cell extracts is used in weight (4-80).

Further, in a method of the invention, the combination of animal proteins from cultivated cells with plant proteins improves the tensile properties of the threads compared to plant proteins alone (4-40 compared to 4-0).

This illustrates that protein threads made according to the method of the invention have desired mechanical properties far above the ones made of plant proteins only.

Moreover, adding some plant proteins can be used to tune the viscoelasticity or flow properties of the protein matrix comprising non-human animal cultivated cells.

### Texture of an Edible Food Product According to the Invention

Texture is among the main parameters for consumer acceptance of food products. However, the reproduction of a meat texture, in particular from cultured cells, is complex.

Table 5 below shows typical Texture Profile Analysis (TPA) characteristics of a conventional marbled beef (Sample 5A), a plant-based meat substitute (Sample 5B) and a composition according to the invention (Sample 5C).

TABLE 5

| | | Hardness 1 | Hardness 2 | Cohesiveness | |
|---|---|---|---|---|---|
| Samples | | (N) | (N) | [TPA] | Fracture (N) |
| Sample 5A | Mean | 121.78 | 85.47 | 0.18 | Not detected |
| (Comp.) | Standard | 25.73 | 18.31 | 0.02 | Not detected |
| | deviation | | | | |
| Sample 5B | Mean | 88.76 | 58.28 | 0.29 | 8.61 |
| (Comp.) | Standard | 9.18 | 10.66 | 0.09 | 1.72 |
| | deviation | | | | |
| Sample 5C | Mean | 127.52 | 88.32 | 0.22 | Not detected |
| (Invention) | Standard | 6.21 | 4.38 | 0.02 | Not detected |
| | deviation | | | | |

As illustrated in table 5, the food product according to the present invention (Sample 5C) shows similar texture properties compared to the conventional meat (Sample 5A). Additionally, the invention shows better performance than the sample 5B, which is a plant-based meat substitute.

In particular, an edible food product according to the invention has hardness 1 or hardness 2 similar or identical to that of a conventional marbled beef. Indeed, whereas a plant-based substitute has a hardness 1 below 90 N, the product comprising edible proteins threads and a fatty matrix according to the invention has a hardness 1 higher than 110 N as the conventional meat product.

Also, the cohesiveness is significantly closer to the conventional product (Sample 5A) with an edible food product according to the invention (Sample 5C) compared to the cohesiveness of a plant-based substitute (Sample 5B).

Interestingly, there is no fracture detected for the edible food product according to the invention (Sample 5C) and the conventional product (Sample 5A) while a fracture value can be measured for the plant-based substitute (Sample 5B). Visually, the protein threads of the plant-based substitute are completely separated after the first compression while the fibers remained cohesive for the edible food product according to the invention, similarly to the conventional product.

Hence, this TPA shows that an edible food product comprising edible protein threads and a fatty matrix having controlled fat marbling according to the invention can have a texture similar and comparable to conventional meat.

### Fat Release Properties of an Edible Food Product According to the Invention

As it has been mentioned, the fat release phenomenon during cooking and chewing is important when evaluating the textural properties of meat products, especially high fat content meat products such as marbled beef. Also, the fat release phenomenon can be correlated to the fat-explosion and mouthfeel that consumers experience while chewing.

As an edible food product according to the invention comprises edible protein threads and a fatty matrix having controlled fat marbling, a way of evaluating its ability to mimic the behavior of a conventional meat product has been to measure the quantity of leaked fat during a pan-fried style cooking.

Table 6 below shows the results of fat release measurements of a conventional beef with marbling (Sample 5A), a plant-based substitute (Sample 5B), and a composition according to the invention (Sample 5C).

TABLE 6

| | | Fat released |
|---|---|---|
| | Fat released | during |
| | during cooking | compression |
| Samples | (w/w %) | (w/w %) |

| | | | |
|---|---|---|---|
| Sample 5A | Mean | 8.31 | 10.67 |
| (Comp.) | Standard | 2.29 | 2.35 |
| | deviation | | |
| Sample 5B | Mean | 4.22 | 2.47 |
| (Comp.) | Standard | 1.05 | 0.51 |
| | deviation | | |
| Sample 5C | Mean | 7.32 | 8.36 |
| (Invention) | Standard | 0.78 | 0.33 |
| | deviation | | |

As illustrated in this table 6, the food product according to the present invention (Sample 5C) shows similar fat release properties compared to the conventional meat food product (Sample 5A). Indeed, whereas the plant-based substitute (Sample 5B) will only leak 4% of its initial weight, a product according to the invention will leak more than 8% of its initial weight during cooking.

The results also show that the product according to the invention has a behavior similar to conventional meat even during cooking. Moreover, an edible food product according to the invention has a cooking behavior similar to the cooking behavior of a conventional meat product and thus reproduces for the consumer the experience of cooking conventional meat food products.

Under conditions of thermal and mechanical stress, such as those occurring when cooking and when chewing, fat release during compression results show that a product comprising edible protein threads embedded into a fatty matrix according to the invention will behave as a conventional meat food product.

Also, such behavior can be correlated to the fat-explosion that the consumer experiences in the mouth when eating marbled beef cuts.

Hence, this fat release measurements shows that an edible food product comprising edible protein threads and a fatty matrix according to the invention has a texture similar to conventional meat.

Thus, in general, the results showed that a food product according to the invention has a texture before cooking, while cooking, after cooking and while chewing, similar to a conventional meat. The food product according to the present invention exhibits overall qualities close to those of conventional meat and matches the consumer experience when cooking and eating conventional meat.

### Sensory Evaluations of the Appearance and the Texture of Edible Food Products

The products according to the invention showed textural properties similar to those of conventional products. To further evaluate organoleptic properties of food products according to the invention, sensory evaluations are conducted on a conventional marbled beef (Sample 5A), a plant-based meat substitute (Sample 5B) and a composition according to the invention (Sample 5C). The sensory evaluations include 16 panelists.

As a result, all 16 trained panelists are able to identify the plant-based meat substitute (Sample 5B). Only 2 panelists are able to guess which is the edible food product preparation according to the invention (Sample 5C), meaning that 90% confused the appearance of edible food product according to the invention with conventional product.

Regarding the texture, all 16 panelists evaluate that the edible food product according to the invention (Sample 5C) is more similar to the conventional meat product (Sample 5A) than the plant-based substitute (Sample 5B) on all evaluated characteristics (tenderness, cohesiveness and juiciness).

Hence, an edible food product comprising edible protein threads and a fatty matrix having controlled fat marbling according to the present invention has similar organoleptic properties to conventional meat.

### Forming an Edible Product Comprising Edible Protein Threads

As it has been described, the method according to the invention can be used to produce an edible food product illustrated in FIG. 3. As it has been mentioned, the invention can relate to an edible food product comprising the edible food product in combination with other food matrices.

The invention can be the subject of numerous variants and applications other than those described above. In particular, unless otherwise indicated, the different structural and functional characteristics of each of the implementations described above should not be considered as combined and/or closely and/or inextricably linked to each other, but on the contrary as simple juxtapositions. In addition, the structural and/or functional characteristics of the various embodiments described above may be the subject in whole or in part of any different juxtaposition or any different combination.

1. Method of manufacturing an edible food product, said method using a protein matrix, and a fatty matrix, said method comprising the following steps:
processing the protein matrix to form one or more edible protein thread(s) using a threading device wherein the formation of the edible protein thread(s) includes a step of wet spinning, a step of dry spinning, a step of electrospinning or a step of dry jet wet spinning and wherein the protein matrix comprises animal proteins, said animal proteins being from non-human cultivated animal cells; preferably the protein matrix comprises disrupted non-human cultivated animal cells and/or intact non-human cultivated animal cells;
guiding the one or more edible protein thread(s) on a collecting device using a guiding device; the guiding device and the collecting device cooperating so as to form an assembly of edible protein thread(s), and wherein the collecting device is moving while cooperating with the guiding device and the movement of the collecting device comprises a rotation; and
adding the fatty matrix on the one or more edible protein thread(s), using a dispensing device; the fatty matrix is added on the edible protein thread(s) while they are being collected by the collecting device so that the fatty matrix is positioned within the assembly of edible protein thread(s).

2. Method of manufacturing according to claim 1, wherein the fat of the fatty matrix comprises at least 4% in weight of stearic acid compared to a total weight of the fat of the fatty matrix.

3. Method of manufacturing according to claim 1, wherein the fat of the fatty matrix comprises at most 35% in weight of palmitic acid compared to a total weight of the fat of the fatty matrix.

4. Method of manufacturing according to claim 1, wherein the fat of the fatty matrix comprises at least 3.5% in weight of polyunsaturated C18 fatty acids compared to a total weight of the fat of the fatty matrix.

5. Method of manufacturing according to claim 1, wherein the protein matrix comprises at least 5% in weight of proteins compared to a total wet weight of the protein matrix and the protein matrix comprises at least 1% in dry weight of cultivated non-human animal cells compared to the total wet weight of the protein matrix.

6. Method of manufacturing according to claim 1, wherein the protein matrix comprises at least 0.25% in weight of myofibrillar proteins compared to a total weight of proteins.

7. Method of manufacturing according to claim 1, wherein the edible protein threads are collected by winding them around the collecting device, creating said assembly of protein threads; the fatty matrix being associated with the edible protein threads as they wind around the collecting device.

8. Method of manufacturing according to claim 1, wherein the guiding device and the collecting device are automatically operated to ensure that the edible protein thread(s) are deposited on the collecting device according to a deposition pattern, said deposition pattern being defined so as to generate an expected marbling pattern in the edible food product.

9. Method of manufacturing according to claim 1, wherein the fat of the fatty matrix comprises at least 20% in weight of unsaturated fatty acids compared to a total weight of the fat of the fatty matrix.

10. Method of manufacturing according to claim 1, further comprising a step of adding an elastomeric protein matrix to the assembly, during its formation, so that the elastomeric protein matrix is positioned within the assembly of edible protein thread(s).

11. Method of manufacturing according to claim 10, wherein the elastomeric protein matrix comprises elastomeric protein selected from: extracellular matrix non-human animal proteins; plant proteins; microorganism proteins; algae proteins; and combination thereof.

12. Method of manufacturing according to claim 10, wherein the elastomeric protein matrix is added on the one or more edible protein threads:
in the form of preformed network, for example in the form of a film like structure;
in the form of a preformed protein-polysaccharide composite network, for example in the form of a film like structure;
through a coaxial spinning process, the elastomeric protein matrix being used on an outer needle;
in the form of a solution, from the moment the edible protein thread is guided by the guiding device to the collecting device; or
in the form of a solution, from the moment the edible protein thread is in contact with the collecting device.

13. Method of manufacturing according to claim 1, wherein the step of processing the protein matrix to form one or more edible protein thread(s) comprises contacting the protein matrix with a coagulation bath to form a said edible protein thread, preferably said protein matrix being at a temperature lower than 65° C.; the protein matrix comprising polyvalent ion or a polyelectrolyte and the coagulation bath comprising a polyvalent ion when the protein matrix comprises a polyelectrolyte or polyelectrolyte when the protein matrix comprises a polyvalent ion.

14. Method of manufacturing according to claim 1, further comprising a step of monitoring, by a monitoring device, the assembly during its formation to generate assembly data, preferably the monitoring comprises an acquisition of a video stream comprising the assembly during its formation.

15. Method of manufacturing according to the claim 14, further comprising a step of controlling the guiding device, the fatty matrix dispensing device and/or the collecting device based on the assembly data, and preferably comprising a modification of initial instructions based on the assembly data.

16. System for manufacturing an edible food product, said system comprising a first container adapted to include a protein matrix and a second container adapted to include a fatty matrix, said system comprising:
a threading device configured to process the protein matrix contained in the first container to form one or more edible protein thread(s) by wet spinning, dry spinning, electrospinning or dry jet wet spinning;
a guiding device configured to guide the one or more edible protein thread(s) on a collecting device; the guiding device and the collecting device being configured to cooperate so as to form an assembly of edible protein thread(s) and wherein the collecting device is configured to move while cooperating with the guiding device and the movement of the collecting device comprises a rotation; and
a dispensing device configured to add the fatty matrix on the one or more edible protein thread(s) so that the fatty matrix is positioned within the assembly of edible protein thread(s).

17. System for manufacturing an edible food product according to claim 16, the guiding device comprises one or more housing(s) for the edible protein thread(s).

18. System for manufacturing an edible food product according to claim 16, the guiding device being configured to move horizontally across a width of the collecting device to guide a fiber of said edible protein thread(s) across a width of the collecting device while maintaining tension and alignment.

19. System for manufacturing an edible food product according to claim 16, wherein the guiding device and the collecting device are parallel to each other, and they rotate in the same direction at the same speed.

20. An edible food product obtainable obtained by the method according to claim 1, said edible food product comprising said assembly of edible protein thread(s) within which is positioned the fatty matrix to form marbled fat domains; the proteins of the edible protein threads comprising at least non-human animal proteins, said non-human animal proteins being cultivated non-human animal cell proteins.
